(19) United States
(12) Patent Application Publication
(10) Pub. No.: US 2026/0100411 A1
(43) Pub. Date: Apr. 9, 2026

(54) SODIUM-DEFICIENT CHLORIDE-BASED SODIUM SOLID ELECTROLYTE

(71) Applicant: THE REGENTS OF THE UNIVERSITY OF CALIFORNIA, Oakland, CA (US)

(72) Inventors: Phillip RIDLEY, La Jolla, CA (US); Ying Shirley MENG, La Jolla, CA (US)

(21) Appl. No.: 19/112,948

(22) PCT Filed: Sep. 25, 2023
(86) PCT No.: PCT/US2023/033637

§ 371 Date: Mar. 18, 2025

Related U.S. Application Data
(60) Provisional application No. 63/409,457, filed on Sep. 23, 2022.

(51) Int. Cl. H01M 10/0562

(52) U.S. Cl. CPC H01M 10/0562; H01M 2300/008

(57) ABSTRACT

A sodium deficient solid electrolyte (SE) exhibits increased ionic conductivity relative to a non-sodium deficient stoichiometric composition through ball milling a mixture of NaCl, YCl3, and ZrCl4 precursor powders with lower molar percentages of NaCl resulting in a composition with reduced or no-crystallinity and an increased concentration of Na vacancies.

### RELATED APPLICATIONS

This application claims the benefit of the priority of U.S. Provisional Application No. 63/409,457, filed Sep. 23, 2022, which is incorporated herein by reference in its entirety.

### GOVERNMENT RIGHTS

This invention was made with government support under Partnerships for Innovation (PFI) Grant No. 2044465 awarded by the National Science Foundation. The government has certain rights in the invention.

### FIELD OF THE INVENTION

The present invention relates to all-solid-state batteries (ASSBs), and more particularly to a sodium solid-state electrolyte with high ionic conductivity and high tolerance to oxidation, which provides stable performance in high-voltage sodium for ASSBs.

### BACKGROUND

As electricity suppliers and users migrate toward renewable energy sources, there is a growing need to implement energy storage devices that can support easy access and high demand while complementing non-continuous natural power sources such as wind and solar. Solid-state battery (SSB) technology has risen to the forefront of energy-storage research for applications ranging from small devices to electric vehicles and grid energy storage. The replacement of volatile and flammable liquid electrolytes (LEs) used in conventional Li-ion batteries (LIBs) with nonflammable solid electrolytes (SEs) is almost universally expected to improve safety. Solid-state batteries are also very promising for energy storage in terms of their much higher energy density, rapid charging rate, and longer lifecycle. The solid electrolyte is the defining feature of ASSBs and plays a significant role in the electrochemical performance of a solid-state cell, especially at room temperature.

All-solid-state batteries (ASSBs) have emerged as a potential solution to the anticipated gap in energy storage capacity by theoretically providing increased energy densities. When considering grid-level energy storage, a sustainable supply of ASSB materials is needed, with a relatively low cost per kilowatt-hour. Sodium ASSBs represent a potential candidate for large-scale applications based on their intrinsically cheaper and more abundant raw materials. Furthermore, sodium ASSBs have been shown to deliver stable long-term cycling, supporting the important goals of long battery life and lower overall cost.

Solid electrolytes (SEs) are the cornerstone of ASSBs, ultimately playing a principal role in the device's performance. Inorganic SEs are a group of materials that can exhibit superionic conductivities at ambient temperature in both lithium- and sodium-based systems, some of which possess conductivities comparable to or even surpassing those of liquid-organic electrolytes. Previously studied ceramic and glass-ceramic materials such as NASICON-type oxide phases, e.g., Na₃PS₄ (NPS), and Na_{2.88}Sb_{0.86} W_{0.11}S₄ sulfides, have exhibited some of the highest Na⁺ conductivities. However, due to the high interfacial resistance between oxide SEs and active material particles, additional high-temperature sintering steps are required to achieve adequate interfacial contact and nullify contact resistance. Consequently, sulfide SEs have attracted a lot of attention due to their high ionic conductivities, while also exhibiting lower bulk moduli and thus better deformability under applied pressure at room temperature. This favorable deformability leads to lower porosity and creates more contact points between active materials and the SE.

Looking beyond their processability, sulfides suffer from narrow electrochemical stability windows, which can lead to severe interfacial degradation reactions during cycling, yielding high interfacial resistance and inducing eventual cell failure. Nevertheless, while protective coatings have been implemented to prevent side reactions between the cathode and SEs, the oxidation of sulfide SEs under high voltage still occurs and results in poor electrochemical performance. Recently, it was shown that a bilayer electrolyte cell design utilizing NPS as the separator layer and a chloride-based catholyte in the cathode composite, can completely avoid interfacial side reactions between NPS and the active material, thus delivering stable long-term cycling. Therefore, developing a highly conductive SE or catholyte material that is stable over a wide range of potentials is essential for ASSB development. Such a material can enable the use of high-voltage cathode materials and improve long-term cyclability without the need for protective coating layers.

Over the past five years, chloride SEs have emerged as promising catholytes, offering excellent electrochemical stability at high voltages, high ionic conductivity, and good cyclability when paired with suitable oxide cathode materials. In 2018, Asano et al. first reported the mechanochemical synthesis of Li₃YCl₆ (LYC), which exhibited a high ionic conductivity of ˜0.5 mS/cm. Interestingly, it was shown that the ionic conductivity of LYC decreased with an increased crystallinity of the phase. In the same work, it was proposed that the Y³⁺ cations in LYC occupy octahedral sites that are alternatively stacked along the c-direction, which can partially block Li⁺ diffusion. However, low crystalline (lc-) LYC possessing Y³⁺ anti-site defects was generated via ball milling, leading to poorer crystallinity and improved ionic conductivity. Sebti et al. showed that, rather than random disorder on the Y lattice, Y layer stacking faults are formed during ball milling and drastically lower Li⁺ diffusion barriers through the structure, thus increasing intragrain transport.²²

Besides crystallinity, the concentration of vacancies also plays an important role in the resultant ionic conductivity. Aliovalent substitutions have been implemented to create additional vacancies that enhance ionic transport. Recently, Liang et al. explored the concept of Li-deficiency in chloride-based LiₓScCl₃₊ₓ (0≤x≤4) SEs, showing that Li⁺ conductivity and activation energy vary significantly depending on the ratio of LiCl to ScCl₃ used during synthesis. Although the accurate structure of these LiₓScCl₃₊ₓ phases remain unclear, the concept is still promising as it can enhance the materials' ionic conductivity without the incorporation of another transition metal. This concept does not appear to have been explored for chloride-based Na⁺ conductors.

Sodium chloride-based materials, primarily of the Na₃MCl₆ and Na₂MCl₆ compositions (M₃₊=Y³⁺, Er³⁺, Gd³⁺ and M⁴⁺=Zr⁴⁺), have emerged as promising catholytes for Na-ASSBs. Mechanochemical syntheses of Na₃YCl₆, Na₃ErCl₆, and Na₂ZrCl₆ have all yielded relatively low Na⁺ conductivities (≤10⁻⁵ S/cm) and have thus required the implementation of aliovalent substitution. Consequently, the syntheses of Na_{3-y}Y_{1-y}Zr_{y}Cl₆ (0≤y≤1) solid solutions were recently reported, whose maximum ionic conductivity was observed at the y=0.75 composition. This increased ionic conductivity was attributed to the introduction of Na vacancies, an optimal unit cell volume, and cooperative MCl₆ rotation. Moreover, it was observed that the ionic conductivity of the y=0.75 composition was lower after crystallization from heat treatment and reached its highest value after amorphization as result of ball milling, further demonstrating this relationship between crystallinity and ionic conductivity in chloride-based SEs. Therefore, the design of Na-chloride SEs should be focused on reducing crystallinity and increasing the concentration of Na vacancies to promote more favorable Na⁺ diffusion.

There are three primary approaches to synthesizing SEs reported in the literature: (1) melt quenching, (2) solution precipitation, and (3) solid-state synthesis, also known as “chemo-mechanical synthesis,” with the latter method being the most widely adopted due to its simplicity and ease of scalability. Although melt quenching and solution precipitation methods have yielded SEs with high phase purity and ionic conductivities, the high melting temperatures (>700° C.) required, along with need for vacuum environments and energy-intensive solvent recovery processes in solution precipitation, make them less-than-optimal for large scale production of SEs. In solid-state synthesis of sulfide- or halide-type SEs, precursor materials are placed in a sealed jar and milled at room temperature and atmospheric pressures until reaction is complete. Although long milling and/or sintering times have been reported in the literature (>48 h or more), this is unnecessary as it possible to achieve the target phases with high ionic conductivities with short durations (1-3 h) after some process optimization, potentially reducing resources needed to scale production of SE materials.

### SUMMARY

A series of Na-deficient chloride solid electrolytes, NaₓY_{0.25}Zr_{0.75}Cl_{3.75+x} (0.25≤x≤0.875), possesses significantly improved ionic conductivities when compared to their stoichiometric counterpart, Na_{2.25} Y_{0.25}Zr_{0.75}Cl₆ (x=2.25). By tuning both the sodium molar content and the sample's crystallinity, the composition Na_{0.625}Y_{0.25}Zr_{0.75}Cl_{4.375} (x=0.625) was found to exhibit the highest Na⁺ conductivity of 0.4 mS cm⁻¹ at room temperature.

The relationship between composition, structure, and conductivity for these compositions in the Na—Y—Zr—Cl system were evaluated using a combination of X-ray diffraction (XRD), solid-state nuclear magnetic resonance spectroscopy (ss-NMR), and electrochemical impedance spectroscopy (EIS) techniques. Materials characterization reveals that sodium-deficiency (i.e., lower molar % of NaCl) results in reduced crystallinity and preferred occupancy of prismatic Na local environments. These combined factors contribute to a lower activation energy for Na⁺ hopping, an increased ionic conductivity, and improved electrochemical performance at both higher cycling rates and at room temperature.

### BRIEF DESCRIPTION OF THE DRAWINGS

FIG. 1A diagrammatically illustrates the variables (V) and factors (F) that can affect the ionic conductivity of the NaₓY_{0.25}Zr_{0.75}Cl_{3.75+x} (0.25≤x≤0.875) SEs; FIG. 1B is a flow diagram of a basic process flow according to an embodiment of the inventive method.

FIG. 2A is a ternary phase diagram between NaCl, YCl₃, and ZrCl₄ precursors, illustrating the molar ratios explored as part of SE Group #1 (Example 1); FIGS. 2B-2G provide various test results for the novel electrolyte, where FIG. 2B provides XRD patterns of NaₓY_{0.25}Zr_{0.75}Cl_{3.75+x} (x=0.875, 0.75, 0.625, 0.5, 0.375, and 0.25) compositions. Bragg peaks corresponding to unreacted NaCl are marked with asterisks. Dashed lines indicate the Bragg feature used for estimating crystallite size; FIG. 2C plots room temperature (˜22° C.) conductivity measurements for NaₓY_{0.25}Zr_{0.75}Cl_{3.75+x} (0.25≤x≤0.875) compositional series; FIG. 2D shows ²³Na ss-NMR spectra recorded on NaₓY_{0.25}Zr_{0.75}Cl_{3.75+x} (x=0.875, 0.75, 0.625, 0.5, 0.375, and 0.25) compositions; FIG. 2E is an Arrhenius plot for NaₓY_{0.25}Zr_{0.75}Cl_{3.75+x} compositional series; FIGS. 2F and 2G respectively provide EIS measurements at room temperature for NaₓY_{0.25}Zr_{0.75}Cl_{3.75+x} (x=0.875, 0.75, 0.625, 0.5, 0.375, and 0.25) compositions and for NaₓY_{0.25}Zr_{0.75}Cl_{3.75} (x=0.625) samples recovered at a heat treatment at 50, 60, 70, and 100° C.

FIGS. 3A-3D provide analysis results for the electrolyte, where FIG. 3A is an Arrhenius plot for the NYZC-0.625 samples recovered after heat treatment at 50, 60, 70, and 100° C.; FIG. 3B provides XRD patterns of NaₓY_{0.25}Zr_{0.75}Cl_{3.75+x} (x=0.625) samples recovered after heat treatment; FIG. 3C plots the relationship between average domain size and ionic conductivity in Na_{0.625}Y_{0.25}Zr_{0.75}Cl_{4.375} (x=0.625) heat-treated samples; FIG. 3D shows ²³Na ss-NMR spectra recorded on Na_{0.625}Y_{0.25}Zr_{0.75}C_{14.375} (x=0.625) heat-treated samples; and FIG. 3E is a schematic depicting [NaCl₆]⁵⁻ octahedral and prismatic environments.

FIG. 4A is a first cycle voltage profile of the Na-deficient NYZC-0.625 phase (x=0.625) and the stoichiometric NYZC-2.25 (2.25) phase at 0.1 C rate; FIG. 4B shows voltage profiles at varying C-rates for NaₓY_{0.25}Zr_{0.75}Cl_{3.75+x} (x=0.625) material; FIG. 4C is a rate study comparison for both NYZC-0.625 and NYZC-2.25 material; FIG. 4D plots results of extended cell cycling at 0.33 C rate for both NYZC-0.625 and NYZC-2.25 materials; FIG. 4E shows voltage profiles corresponding to the extending cycling data. Cycles 10, 50, and 200 are indicated for both samples; FIG. 4F shows the electrochemical stability window of Na_{0.625}Y_{0.25}Zr_{0.75}Cl_{4.375} (x=0.625) solid electrolyte material.

FIG. 5A provides the EIS measurement and the fitted result for the highest conducting sample Na_{0.625}Y_{0.25}Zr_{0.75}C_{14.375} (x=0.625). FIG. 5B shows the direct current polarization measurement using a 50-mV applied potential.

FIG. 6A is a ternary composition diagram of NaCl—YCl₃—ZrCl₄ precursor compounds, which demonstrates the molar ratios explored in SE Group #2 (Example 2); FIG. 6B provides XRD patterns of Na_{2.25-x}Y_{0.25}Zr_{0.75}Cl₆₋ₓ (1.375≤x≤2) SEs; FIG. 6C shows zoomed in XRD patterns of Na_{2.25-x}Y_{0.25}Zr_{0.75}Cl₆₋ₓ (1.375≤x≤2) SEs, highlighting the main diffraction peaks in the 5-9 2θ range.

FIG. 7 shows sample microstructure and crystallinity, where panels a-c are transmission electron microscope images for Na_{2.25-x}Y_{0.25}Zr_{0.75}Cl₆₋ₓ materials (x=1.375, 1.625, and 2.000, respectively), and panels d-f show selected area electron diffractions for Na_{2.25-x}Y_{0.25}Zr_{0.75}Cl₆₋ₓ materials (x=1.375, x=0.1625, and x=2.000, respectively).

FIGS. 8A-8D provide Na local environments and ionic conductivity measurements, where FIG. 8A shows room temperature 23Na ss-NMR spectra collected on the various Na_{2.25-x}Y_{0.25}Zr_{0.75}Cl₆₋ₓ (1.375≤x≤2) compositions at 18.8 T and at a magic angle spinning frequency of 12 kHz; FIG. 8B plots room temperature ionic conductivity measurements with fits (equivalent circuit model shown above) for the various Na_{2.25-x}Y_{0.25}Zr_{0.75}Cl₆₋ₓ (1.375≤x≤2) compositions; FIG. 8C provides a comparison of room temperature ionic conductivities and activation energies for the various Na_{2.25-x}Y_{0.25}Zr_{0.75}Cl_{6-c} (1.375≤x≤2) compositions; and FIG. 8D plots Arrhenius conductivity for the various Na_{2.25-x}Y_{0.25}Zr_{0.75}Cl₆₋ₓ (1.375≤x≤2) compositions.

FIGS. 9A-9D illustrate the effect of solid electrolyte crystallinity on ionic conductivity, where FIG. 9A plots X-ray diffraction patterns for the ball milled and heat-treated x=1.625 and x=2.000 compositions. Asterisk (*) indicates XRD peaks attributed to NaCl and circumflex (\hat{ }) indicates the XRD peak ascribed to ZrCl₄; FIG. 9B shows room temperature ²³Na ss-NMR spectra for the x=1.625 and x=2.000 compositions at 18.8 T and at a magic angle spinning frequency of 12 kHz. The asterisk (*) indicates the NaCl resonance; FIG. 9C plots Arrhenius conductivity for the ball milled and heat-treated x=1.625 and x=2.000 compositions; and FIG. 9D provides comparison bar plots of room temperature ionic conductivity (left bars) and activation energy (right bars) for the ball milled and heat-treated x=1.625 and x=2.000 compositions.

FIG. 10A shows the oxidation and reduction linear sweep voltammetry curves for x=1.625 and x=2.000 samples of the Na_{2.25-x}Y_{0.25}Zr_{0.75}Cl₆₋ₓ composition series. (Note the difference in scaling for the left-hand and right-hand x axis); FIG. 10B provides a comparison of electrochemical active windows for various sodium-based cathode materials.

FIGS. 11A-11E illustrate electrochemical performance of nanocrystalline and amorphous SEs, where FIG. 11A provides the first cycle voltage profile of Na_{0.625}Y_{0.25}Zr_{0.75}Cl_{4.375} (x=1.625) and Na_{0.25}Y_{0.25}Zr_{0.75}Cl₄ (x=2.000) catholytes paired with a NaCrO₂ cathode; FIG. 11B compares voltage profiles at varying C-rates for Na_{0.25}Y_{0.25}Zr_{0.75}Cl₄ (x=2.000) material; FIG. 11C provides a rate study comparison for Na_{0.625}Y_{0.25}Zr_{0.75}Cl_{4.375} (x=1.625) and Na_{0.25}Y_{0.25}Zr_{0.75}Cl₄ (x=2.000) materials; FIG. 11D shows extended cell cycling at 0.33 C rate for Na_{0.625}Y_{0.25}Zr_{0.75}Cl_{4.375} (x=1.625) and Na_{0.25}Y_{0.25}Zr_{0.75}Cl₄ (x=2.000) materials, and FIG. 11E compares voltage profiles corresponding to the extending cycling data for Na_{0.25}Y_{0.25}Zr_{0.75}Cl₄ (x=2.000) solid electrolyte.

### DETAILED DESCRIPTION OF EMBODIMENTS

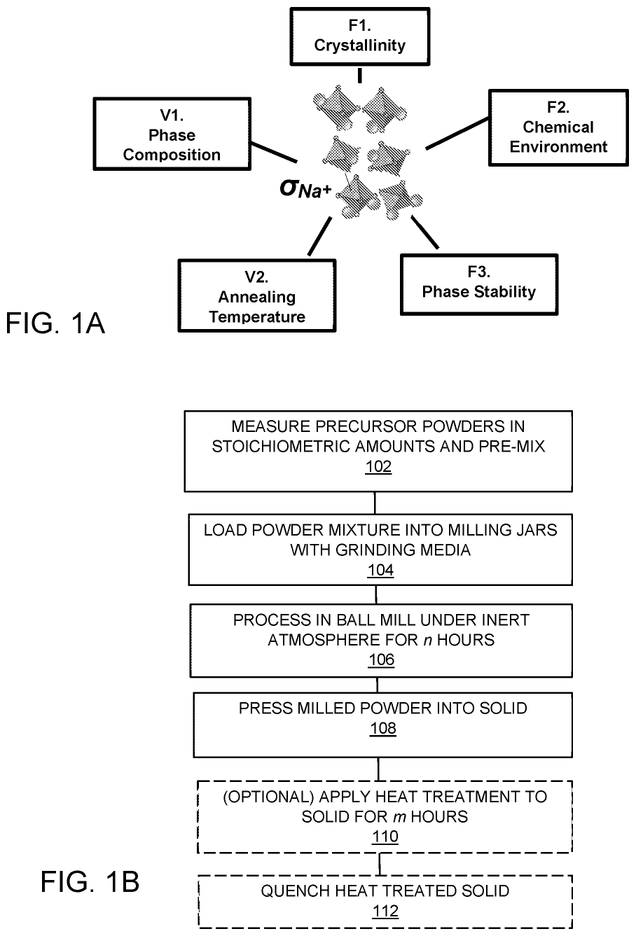

The synergistic effects of crystallinity and Na-deficiency on the ionic conductivity of Na_{3-y}Y_{1-y}Zr_{y}Cl₆ SEs were investigated. To minimize the total number of variables, the Y:Zr ratio was fixed at 1:3, corresponding to the highest ionic conductivity previously observed in the Na_{3-y}Y_{1-y}Zr_{y}Cl₆ series. The NaCl molar % was varied, leading to a compositional series of Na-deficient samples, NaₓY_{0.25}Zr_{0.75}Cl_{3.75+x} (0.25≤x≤0.875). The possible variables and factors which can affect the ionic conductivity of the SEs are shown in FIG. 1A. Specifically, the variables included phase composition and annealing temperature while the factors of interest were crystallinity, chemical environment, and phase stability.

FIG. 1B provides a flow diagram of the basic process flow used for synthesis of the solid electrolytes (SEs) according to embodiments described herein. High purity precursor powders are premixed in a non-reactive container in step 102 and the resulting mixture is loaded into a milling jar with the grinding media (step 104), which may be yttrium-stabilized zirconia. The volume of grinding media will typically be at a relatively high mass ratio relative to the powder volume, e.g., 10:1 to 50:1. The jar is sealed, preferably under inert atmosphere, and loaded into a ball mill. (step 106) In some ball mills, the jar may include a special aeration lid to maintain the inert atmosphere within the jar. As is known in the art, ball milling induces structural, morphological, and microstructural modification of materials by energetic impacts, intensive friction, and controlled container movements. This technique can also induce chemical reactions that may not normally occur at room temperature. Depending on the movement of the balls/media and the jar, various types of milling devices classified as planetary, vibrational, rotational, magnetic and attrition mills. The properties of the milled material depend on many parameters such as the type of mill, milling speed or frequency, milling time, milling atmosphere, ball-to-powder weight ratio, etc. During the milling process, significant heat is locally generated, which can affect the process. In some ball milling systems such as the Retsch E_{MAX}, water cooling may be employed to permit continuous operation. Typical processing time (n) will be on the order of 1 to 10 hours to achieve the mixing and desired particle size but will depend on the size and type of the mill and volume of material to be processed. It has been demonstrated that laboratory-scale milling processes can be scaled up to industrial-scale milling with adjustment of variables based on the types of mills. For example, the milling time with a low energy mill may take on the order of 10× longer than with a high energy mill, and therefore may require a water cooled mill and/or pauses in processing to avoid excessive heating. Nonetheless, it will be readily apparent to those of skill in the art that the processes described herein can be expanded to industrial scale production with adjustments to the processing conditions.

After completion of milling, the resulting powder mixture may be pressed into a pellet or other solid structure (step 108). In optional processing step 110 (indicated by a dashed box), the solid pellet may be sealed into a glass tube with an inert atmosphere and placed in a furnace for heat treatment in step 110. The temperature and duration of the heat treatment (annealing) may vary depending on the desired effect. An exemplary range for annealing time (m) is 1 to 5 hours. If heat treatment is applied, upon completion, the solid sample is quenched to produce the sample for testing (step 112).

Two different SE groups were synthesized according to the basic processing sequence and evaluated to confirm that sodium-deficiency (i.e., lower molar % of NaCl) results in reduced (minimal or nanocrystalline) or non-crystallinity (amorphous) and preferred occupancy of prismatic Na local environments, contributing to a lower activation energy for Nat hopping, increased ionic conductivity, and improved electrochemical performance at both higher cycling rates and at room temperature. These SE groups are discussed below as Example 1 and Example 2.

### Example 1: SE Group #1

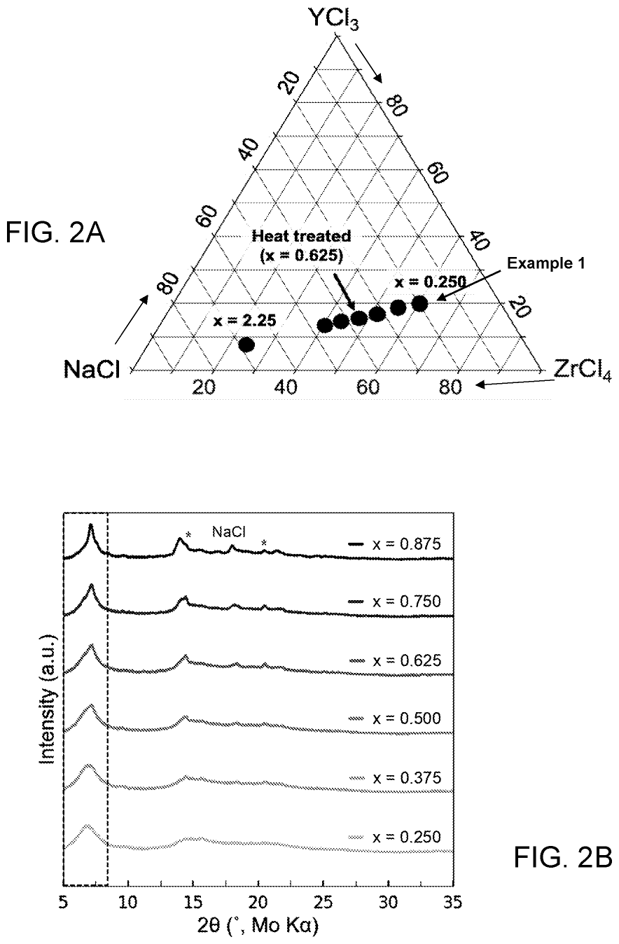

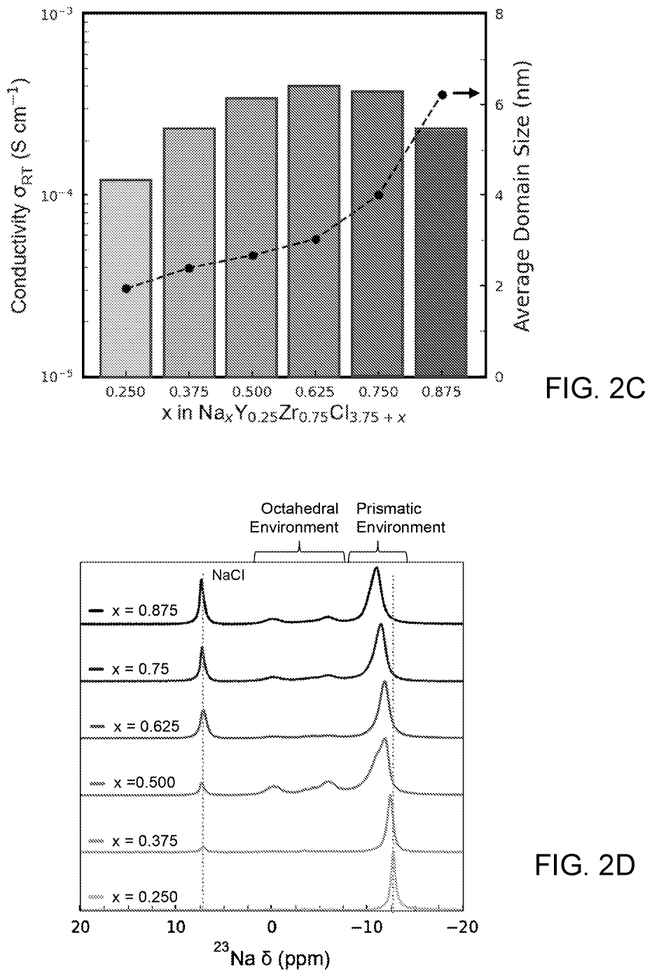

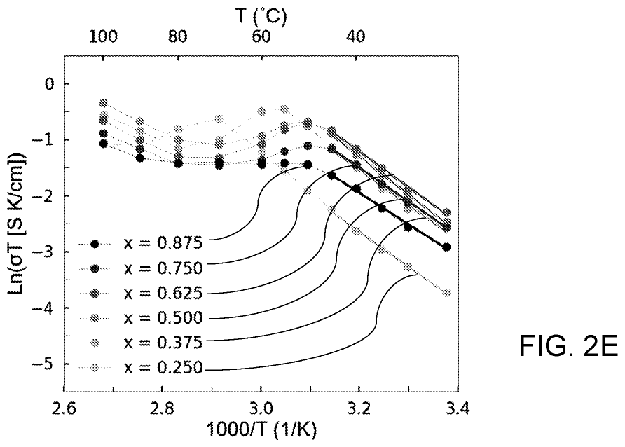

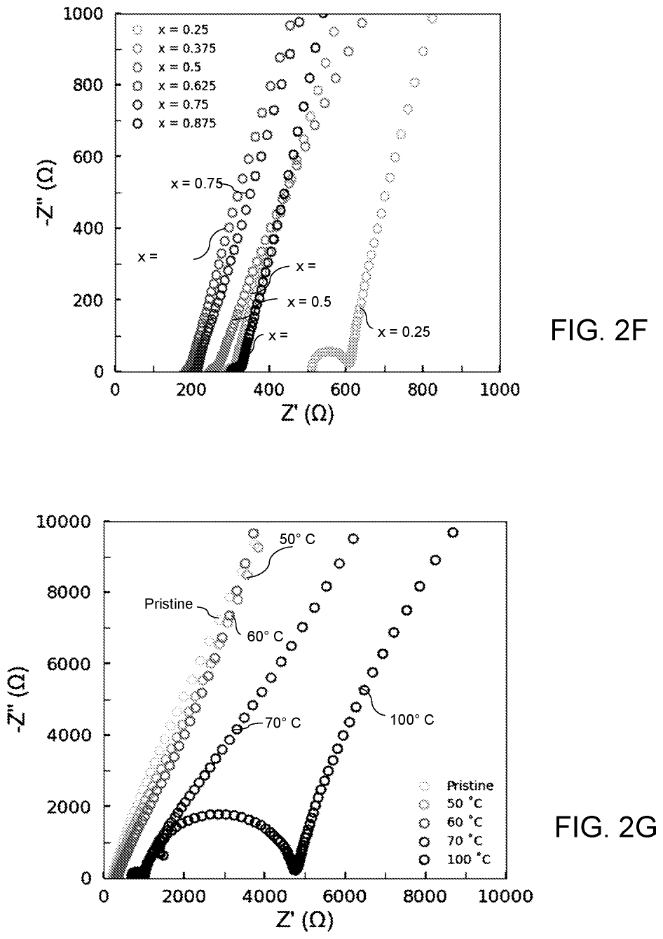

FIG. 2A provides the NaCl—YCl₃—ZrCl₄ ternary phase diagram, where the black dots represent the intersection points corresponding to the various molar ratios that were evaluated, e.g., NaₓY_{0.25}Zr_{0.75}Cl_{3.75+x} (0.25≤x≤0.875) or NaₓYZCₓ.

### Preparation of SE Group #1 Samples:

All materials were synthesized under an inert Ar atmosphere. NaCl (Sigma-Aldrich, 99%), YCl₃ (Sigma-Aldrich, 99.9%), and ZrCl₄ (Sigma-Aldrich, 99.9%) anhydrous powders were used as received from the materials vendor. Mechanochemical synthesis was carried out using a high-energy Retsch E_{MAX} ball mill. Typical ranges for milling may be 1-20 hours at 400-600 rpm. For Group #1 sample evaluation, milling time was around 5 h at 500 rpm, and a 30:1 mass ratio of 5 mm yttrium-stabilized zirconia (Y—ZrO₂) grinding media to precursor powder was used. 1 g of stoichiometric amounts of NaₓY_{0.25}Zr_{0.75}Cl_{3.75+x} (where x=0.25, 0.375, 0.5, 0.75, 0.875) powder were prepared by pre-mixing the NaCl, YCl₃, and ZrCl⁴ precursor powders before being loaded into the milling jars. Milling was considered complete once particle sizes were reduced to less than or equal to 20 μm and/or crystallites with nano-sized, i.e., <100 nm, were obtained. The Na_{0.625}Y_{0.25}Zr_{0.75}Cl_{4.375} composition was subjected to heat treatments to induce crystallization. The powder was first cold pressed into pellets and then loaded into quartz ampoules, which were then flame sealed under vacuum. The samples were heated at various temperatures (50, 60, 70, and 100° C.) for a period within a range of 1-24 hours after which the sample was air quenched. For Group #1 sample evaluation the annealing period was 2 h.

Na₃PS₄ powder was synthesized as follows: Na₂S (Sigma Aldrich 98% or Nagao 99.6%) and P₂S₅ (Sigma Aldrich 99%) was loaded into a milling jar at a molar ratio of 75:25, respectively. The total mass of the mixture was 1 g. The milling jar volume is 50 mL with an inner lining made of Y—ZrO₂ (Retsch). The jar was preloaded with ZrO₂ grinding media where an 8.7:1 jar to grinding-media volume ratio was maintained. The loaded jar was sealed in an Ar-containing glovebox and the milling proceeded under inert conditions using a Retsch PM100 planetary ball mill. Ball milling proceeded at 550 RPM unless stated otherwise. The samples were loaded into a quartz tube and flame-sealed and heat-treated in a box furnace (Lindberg Blue M). The temperature was ramped from room temperature to 270° C. at a rate of 10° C. min 1 and held for two hours at temperature. The sealed tube was then quenched in ice water and the sample extracted for characterization Na₄(B₁₂H₁₂) (B₁₀H₁₀) powders were prepared by ball milling a stoichiometric ratio of Na₂B₁₀H₁₀ and Na₂B₁₂H₁₂ precursor powders together for a total of 2 h at 500 rpm.

### Experimental Procedures:

### X-ray Diffraction Measurements:

XRD patterns were collected over a 5-50° 2θ range with a step size of 0.01° using a Bruker X8-ApexII CCD Sealed Tube diffractometer equipped with a molybdenum source radiation (λ_{Mo}=0.7107 Å). All samples were hermetically sealed in 0.5 mm diameter boron-rich capillary tubes. Full width at half maximum values were extracted from the first Bragg peak using OriginLab and the average domain size was calculated following the Scherrer equation.

### ²³ Na Solid-State Nuclear Magnetic Resonance Measurements:

²³Na measurements were performed using a 3.2 mm HX probe and a Bruker Advance III Ultrashield Plus 800 MHz spectrometer, equipped with an 18.8 T wide-bore magnet (operating at the Larmor frequency of 132.3 MHz for ²³Na). Experiments were performed using a 3.2 mm MAS probe with a 12 kHz MAS rate. All samples were prepared inside the glovebox to avoid direct contact with moist in the ambient atmosphere. Room temperature spectra were collected on the various NaₓY_{0.25}Zr_{0.75}Cl_{3.75+x} compositions (where x=0.25, 0.375, 0.5, 0.625, 0.75, 0.875). Moreover, room temperature spectra were also collected on the heat treated Na_{0.625}Y_{0.25}Zr_{0.75}C_{14.375} samples (50, 60, 70, and 100° C.). A single pulse length of 0.29 μs at 200 W corresponding to a π/6 excitation pulse with a recycle delay of 10 s was used for all acquisitions. Given the quadrupolar nature of ²³Na, pulses with a π/6 flip angle were leveraged to uniformly excite all resonances. All ²³Na NMR shifts were referenced relative to a 1 M aqueous solution of NaCl. The data was processed and extracted using TopSpinR software (Bruker Corporation, Billerica, MA) and ssNake open-source NMR software (Radboud University, Nijmegen, NL), respectively.

### Conductivity Measurements:

The ionic conductivity of the solid electrolytes was extracted from electrochemical impedance spectroscopy (EIS) measurements. 10 mm diameter Ti|SE|Ti cells were assembled using a polyether ether ketone (PEEK) die, where SE pellets were formed by cold pressing at a pressure of ˜370 MPa. The EIS data was acquired using a Solartron 1260A impedance analyzer (AMETEK Scientific Instruments) with a sinusoidal amplitude of 30 mV within a frequency range of 1 MHz to 1 Hz. Activation energies of the ionic conduction were determined through the linear regression of the Arrhenius plot: ln(σT)∝1/T. The electronic conductivity of the solid electrolytes was determined using direct current polarization with an applied bias of 50 mV.

### All-Solid-State Battery Testing

Electrochemical performance of the SEs was tested with the cell configuration Na₂Sn|Na₃PS₄|Cathode composite with the respective amounts of 35, 50, and 12 mg of each material. The cathode composites comprised of NaCrO₂, NaₓY_{0.25}Zr_{0.75}Cl_{3.75+x} (where x=0.625 or 2.25), and vapor grown carbon fiber (VGCF) conductive carbon additive in a weight ratio of 11:16:0.5. To prevent interfacial degradation between the Na₃PS₄ and Na₂Sn, 10 mg of Na₄(B₁₂H₁₂) (B₁₀H₁₀) was used as a protective layer. Constant current cycling of the fabricated cells was carried out at an ambient temperature of roughly 23° C. within the voltage range of 1.7-3.4 V and under an applied stack pressure of ˜70 MPa.

### Test Results

Test results reveal that Na-deficiency along with low crystallinity helps to increase the ionic conductivity of the samples when compared to the stoichiometric composition, Na_{2.25} Y_{0.25}Zr_{0.75}Cl₆ (NYZC-2.25), which is not Na-deficient. The enhanced ionic conductivity is attributed to synergistic effects between low crystallinity, Na⁺ vacancies, and prismatic Na local environments, all of which serve to improve the performance of ASSBs, especially at high cycling rates and at room temperature.

Structural Analysis and Ionic Conductivity Measurements. The X-ray diffraction (XRD) patterns shown in FIG. 2B indicate that few and low-intensity Bragg reflections were observed in all samples. In addition, no significant signals from the Bragg peaks of NaCl, YCl₃, or ZrCl₄ were observed after the ball-milling process, except for a small amount of unreacted NaCl precursor detected when x>0.5 in NaₓYZCₓ. Furthermore, all diffraction peaks were broad, indicating a low crystallinity or an amorphous state of the synthesized products. As the molar ratio of NaCl was decreased from x=0.875 to x=0.25, a broadening of the major reflection at 2θ˜7.2° (dashed line) is clearly observed. This can be an indication of a reduction in the average crystallite domain size and thus a lower crystallinity. To quantify the degree of crystallinity of the samples, the full width at half maximum (FWHM) of the main reflection at 2θ˜7.2° was used to estimate the average domain size of the crystallites according to Scherrer's equation (Equation 1):

$$τ = \frac{K λ}{β cos θ} \qquad Equation ( 1 )$$

where τ is the mean size of the coherent domain, K is the shape factor, λ is the X-ray radiation wavelength, β is the FWHM of the peak of interest, and θ is the Bragg angle. FIG. 2C shows that when the NaCl content was reduced from x=0.875 to x=0.625, the average domain size decreases from ˜6 nm to ˜3 nm. Bragg peaks corresponding to unreacted NaCl are marked with asterisks. Dashed lines indicate the Bragg feature used for estimating crystallite size. The molar content of NaCl is directly correlated to the crystallinity of the phase, where reducing NaCl amounts lead to lower crystallinity. At the composition where the molar content of NaCl is lowest (x=0.25), Bragg peaks are essentially non-existent and the main reflection is significantly broadened, indicating that the obtained phase is highly disordered and lacks significant long-range order.

Due to the low crystallinity of the NaₓY_{0.25}Zr_{0.75}Cl_{3.75+x} (0.25≤x≤0.875) compositional series, the local Na environments were investigated using ²³Na solid-state nuclear magnetic resonance (ss-NMR) spectroscopy. Room temperature ²³Na ss-NMR spectra were acquired on all NaₓYZCₓ compositions and are shown in FIG. 2D. The peak located around 7.2 ppm, which is observed in all samples, can be attributed to minor amounts of unreacted NaCl precursor. As the molar ratio of NaCl decreases, there is a corresponding reduction in NaCl signal, which is in good agreement with the XRD results. The two weak and broad signals detected in the range of −2.5-8 ppm are attributed to octahedral Na environments, while the intense resonance around −10 to −13 ppm is attributed to prismatic Na environments, both of which are assigned according to the recently reported local structure of the crystalline analogue.³¹ Interestingly, the prismatic signal can be clearly observed even at very low NaCl molar percentages, while the signals corresponding to octahedral environments can only be detected when x>0.5. This observation reveals that Na⁺ cations preferentially occupy prismatic environments, which is similar to what has been reported in some Na-based layered oxides and other chloride SEs.^{23,32} Additionally, the resonance of the prismatic environment narrows significantly when x<0.5, indicating a likely increase in the mobility of Na⁺ at lower NaCl molar percentages.

Nyquist plots corresponding to the raw data are provided in FIGS. 2F and 2G, which respectively provide EIS measurements at room temperature for NaₓY_{0.25}Zr_{0.75}Cl_{3.75+x} (x=0.875, 0.75, 0.625, 0.5, 0.375, and 0.25) compositions and for NaₓY_{0.25}Zr_{0.75}Cl_{3.75} (x=0.625) samples recovered at a heat treatment at 50, 60, 70, and 100° C.

All SE samples exhibited high Na⁺ conductivities (>1.0×10⁻⁴ S cm⁻¹), with a maximum value of 4.0×10⁻⁴ S cm⁻¹ at the x=0.625 composition. These values are significantly higher than what has been previously reported for the stoichiometric Na_{2.25}Y_{0.25}Zr_{0.75}Cl₆ (6.6×10⁻⁵ S cm⁻¹) phase. Interestingly, the sample with the lowest mol % of NaCl (x=0.25) still exhibited an ionic conductivity comparable to NPS and is still higher than all other previously reported chloride-based Na⁺ SEs.

The ionic conductivity of a single ion conductor is determined by the relation:

$$σ = {n}_{i} {q}_{i} {μ}_{i} \qquad Equation ( 2 )$$

where σ is the ionic conductivity, nᵢ is the number of charge carriers of species i, qᵢ is the charge of species i, and μᵢ is the mobility of species i.

Glassy or amorphous SEs usually possess lower densities than their crystalline counterparts, allowing for the presence of additional free volume, which is attributed to their non-periodicity and lower packing densities. Moreover, free volume has been shown to promote more favorable ionic diffusion and thus enhances ionic conductivity. Without intending to be bound by theory, it can be speculated that the low crystalline NaₓYZCₓ compositions should possess higher free volume compared to the stoichiometric Na_{2.25c}Y_{0.25}Zr_{0.75}Cl₆ system, which may contribute to the improved Na⁺ mobility. Moreover, since the total conductivity is a product of n_{Na} and μ_{Na}, an optimum balance between the two is expected to achieve the highest conductivity. On one hand, there will not be enough charge carriers when the concentration of Na⁺ is too low. Conversely, the number of vacancies and free volume will be significantly reduced at higher NaCl molar percentages, resulting in lower Na⁺ mobility. As such, Na_{0.625}Y_{0.25}Zr_{0.75}Cl_{4.375} (NYZC-0.625) appears to be preferred composition due to a balancing between the available volume free and the concentration of mobile Na⁺ cations.

Referring to FIG. 2E, the Arrhenius plots for all NaₓYZCₓ compositions show that the ionic conductivities measured at room temperature (˜22° C.), In (GT) versus f(1/T), evolves linearly at temperatures below ˜50° C. and the activation energy for Na⁺ diffusion can then be extracted using the Arrhenius equation:

$$σ = \frac{{σ}_{0}}{T} {e}^{- \frac{{E}_{a}}{{k}_{B} T}} \qquad Equation ( 3 )$$

where σₒ is the Arrhenius pre-factor, Eₐ is the activation energy, and k_{B} is the Boltzmann constant.

All NaₓYZCₓ compositions possessed activation energies in the range of 480-540 meV (Table 1), which are appreciably lower than the stoichiometric Na_{2.25}Y_{0.25}Zr_{0.75}Cl₆ (664 meV) phase. Surprisingly, as shown in FIG. 2E, all of the NaₓYZCₓ compositions deviated from this ln(σT)∝1/T linear relationship at temperatures above ˜50° C. This deviation from linearity was accompanied by a drop in the sample's ionic conductivity and a return to linear ln(σT)∝1/T behavior at higher temperatures. The temperature at which these deviations occur appears to vary with the composition and the crystallinity of the sample, where a higher transition temperature was observed for lower NaCl molar percentages.

TABLE 1

| | | σ_{Na} | Eₐ | Transition |
|---|---|---|---|---|
| Composition | Composition (norm.) | (S cm⁻¹) | (meV) | Temp. (° C.) |
| 7NaCl•2YCl₃•6ZrCl₄ | Na_{0.875}Y_{0.25}Zr_{0.75}Cl_{4.625} | 2.3 × 10⁻⁴ | 485 | 50 |
| 6NaCl•2YCl₃•6ZrCl₄ | Na_{0.750}Y_{0.25}Zr_{0.75}Cl_{4.500} | 3.8 × 10⁻⁴ | 523 | 50 |
| 5NaCl•2YCl₃•6ZrCl₄ | Na_{0.625}Y_{0.25}Zr_{0.75}Cl_{4.375} | 4.0 × 10⁻⁴ | 539 | 50 |
| 4NaCl•2YCl₃•6ZrCl₄ | Na_{0.500}Y_{0.25}Zr_{0.75}Cl_{4.250} | 3.4 × 10⁻⁴ | 569 | 50 |
| 3NaCl•2YCl₃•6ZrCl₄ | Na_{0.375}Y_{0.25}Zr_{0.75}Cl_{4.125} | 2.3 × 10⁻⁴ | 509 | 55 |
| 2NaCl•2YCl₃•6ZrCl₄ | Na_{0.250}Y_{0.25}Zr_{0.75}Cl_{4.000} | 1.2 × 10⁻⁴ | 516 | 70 |

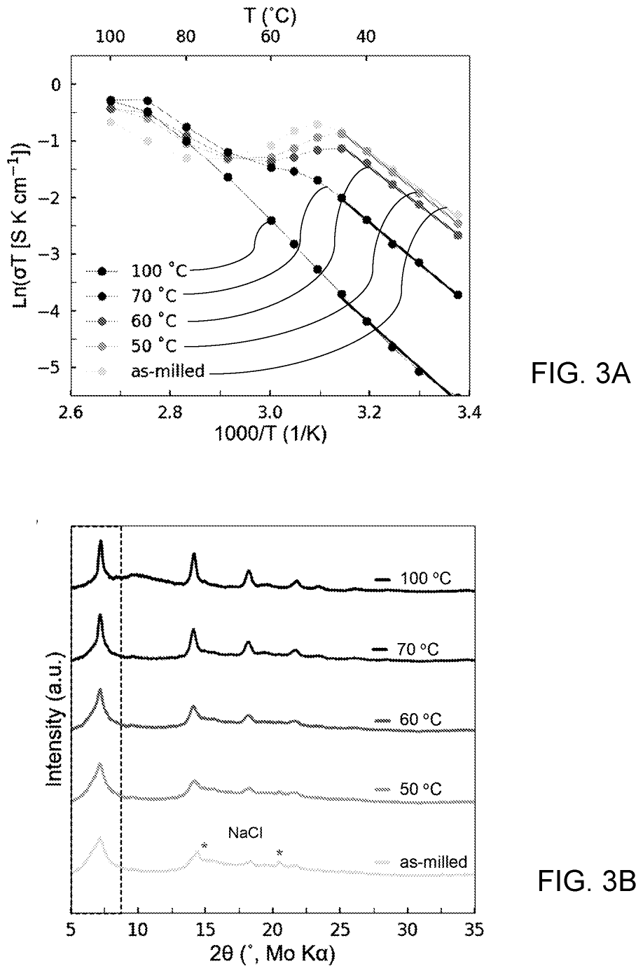

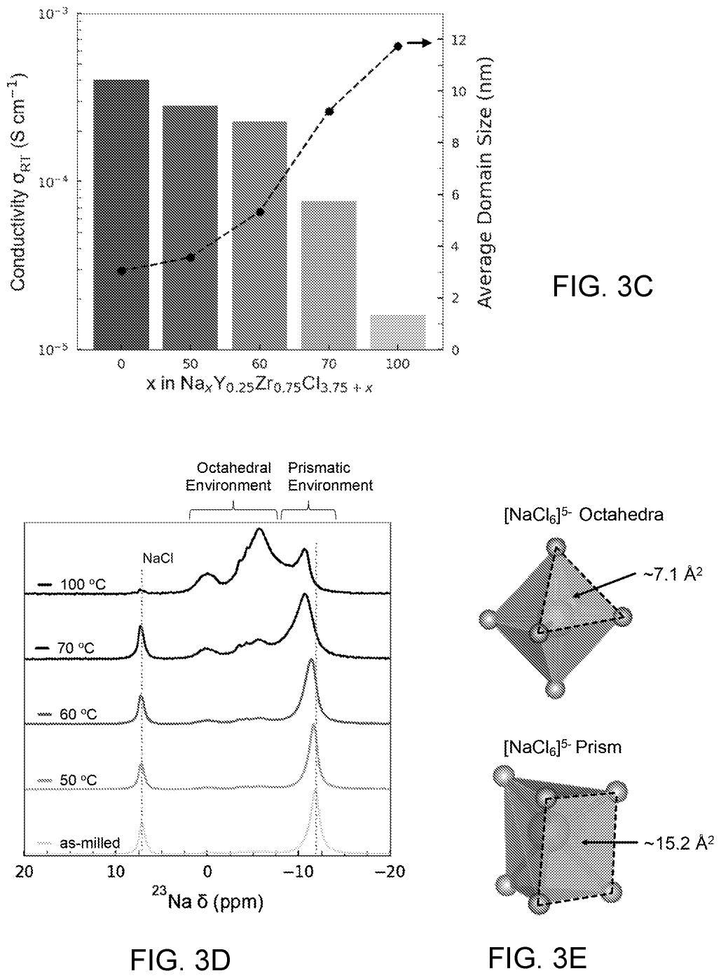

Non-linear Arrhenius Behavior. To better understand the non-linear Arrhenius behavior, the preferred composition with the highest ionic conductivity, NYZC-0.625, was selected for further study. The sample was heat-treated at different temperatures (50, 60, 70, and 100° C.), and the measured ionic conductivities and activation energies of the recovered powders are shown in FIG. 3A and Table 2, respectively.

TABLE 2

| Heat Treatment | σ_{Na} | Eₐ |
|---|---|---|
| Temp. (° C.) | (S cm⁻¹) | meV) |
| 100 | 2.0 × 10⁻⁵ | 678 |
| 70 | 8.0 × 10⁻⁵ | 629 |
| 60 | 2.3 × 10⁻⁴ | 574 |
| 50 | 2.8 × 10⁻⁴ | 590 |
| Pristine | 4.0 × 10⁻⁴ | 549 |

Samples that were subjected to higher heat treatment temperatures exhibited lower ionic conductivities and increased activation energies, which agrees well with many other chloride SEs reported in the literature. Notably, the Arrhenius plot of the samples heated at 50, 60, and 70° C. still exhibited non-linear behavior at elevated temperatures. However, the temperature where the deviation occurred shifted to higher values compared to the as-milled sample. Surprisingly, the sample treated at 100° C. showed a linear ln(σT)∝1/T relationship throughout the whole temperature range (FIG. 3A), indicating that the heat treatment parameters produced a significant variation in the sample's structure.

XRD patterns of the NYZC-0.625 powders recovered after the various thermal treatments are shown in FIG. 3B. Upon heating, all diffraction peaks appeared to become narrower, providing evidence of a crystallization process. The average size of the coherent domains, determined again from the diffraction peak at 7.2°, grew gradually until reaching a maximum value of ˜12 nm at 100° C. and was accompanied by drops in the ionic conductivity (FIG. 3C). The corresponding ²³Na ss-NMR spectra show that more NaCl was consumed and incorporated into the main structure when the sample was heated at higher temperatures (FIG. 3D). Furthermore, the resonance corresponding to prismatic Na sites decreased while those of octahedral Na environments grew significantly. Therefore, higher heat treatment temperatures promote crystallization of the phase, accompanied by a preferential population of octahedral over prismatic Na sites. Referring to FIG. 3E, a simple geometry comparison between the two polyhedra reveals that the cross-sectional areas of prismatic [NaCl₆]⁵⁻, in which Na ions diffuse through, are significantly larger than those of octahedral [NaCl₆]⁵⁻. Thus, it is possible that the Na⁺ hopping between prismatic sites requires lower activation energy, thus leading to more favorable Na diffusion. Previous studies on P2-type layered manganese oxides have also reported fast Na⁺ self-diffusion via edge- and face-sharing prismatic Na sites. Without intending to be bound by theory, the preferential population of prismatic environments appears to be one of the factors aiding the Na-deficient compositions NaₓYZCₓ to achieve enhanced ionic conductivity.

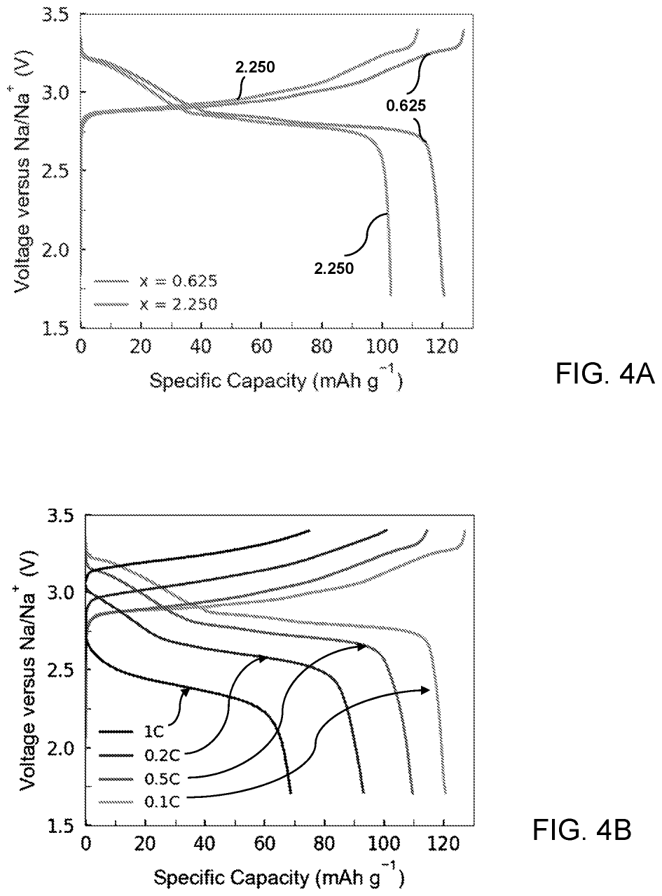

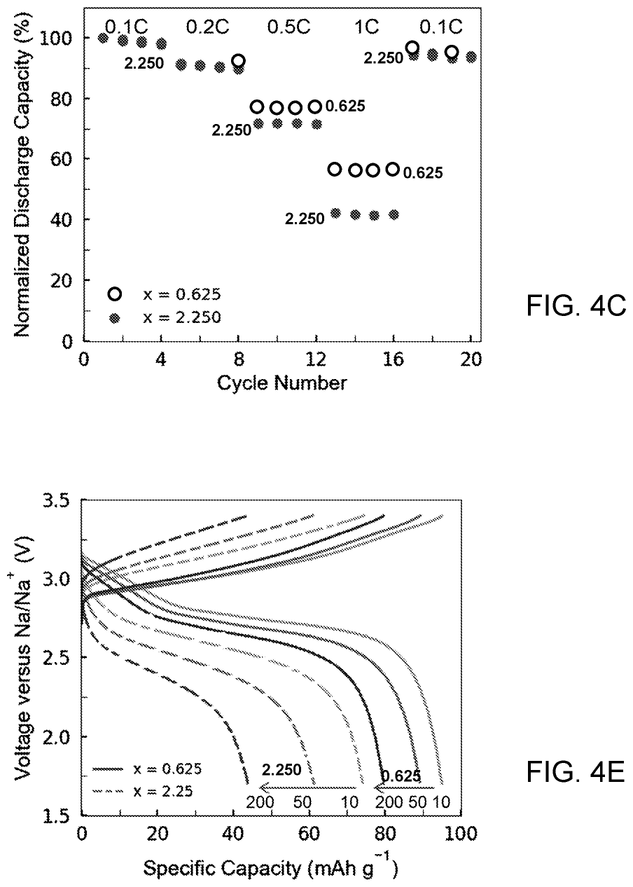

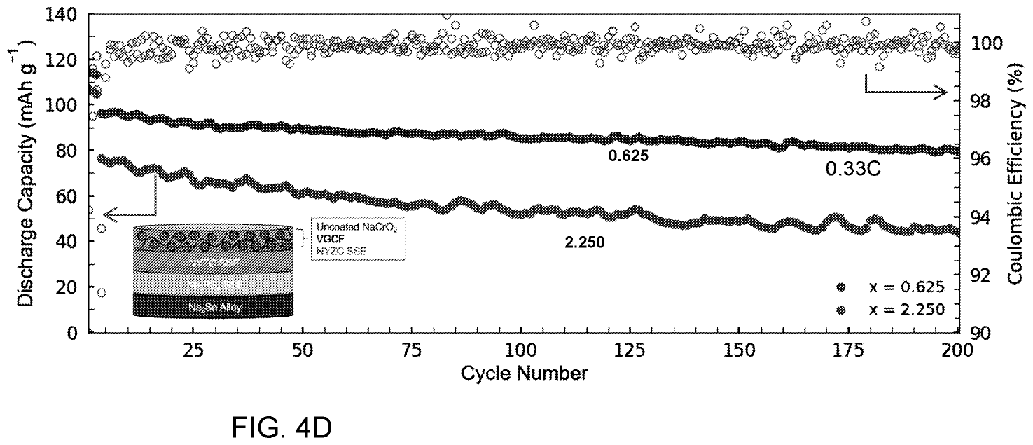

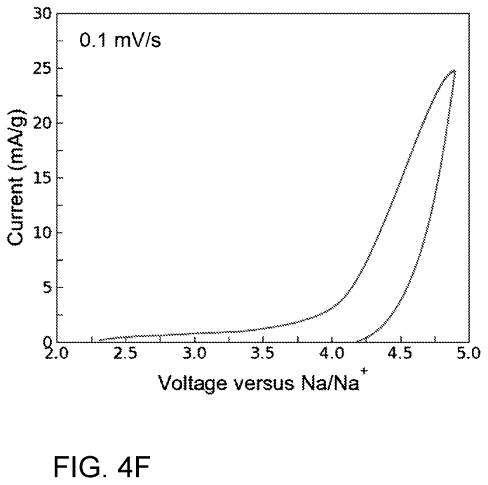

Electrochemical Testing. To examine the effect of Na-deficiency on the electrochemical performance of a solid-state battery, a cell using the Na-deficient NYZC-0.625 phase as a catholyte was compared to one comprising the stoichiometric NYZC-2.25 phase (FIG. 4A). At room temperature and a 0.1 C current rate (where 1 C=120 mA g⁻¹ and 71 μA cm⁻²), the Na-deficient catholyte cell exhibited a higher first cycle Coulombic efficiency (CE) of ˜95% compared to ˜92% for Na_{2.25}Y_{0.25}Zr_{0.75}Cl₆. Moreover, the Na-deficient phase delivered higher initial charge and discharge capacities compared to those of stoichiometric Na_{2.25}Y_{0.25}Zr_{0.75}Cl₆ (FIG. 4A). These higher capacity values can be attributed to the higher ionic conductivity and more favorable SE deformability due to the low crystallinity nature of the sample, which leads to an improved contact between cathode and SE particles, and a better of utilization of the cathode active material in the composite.

Rate capability tests using a sequence of 0.1, 0.2, 0.5, 1, and 0.1 C current rates also reveal that the Na-deficient phase exhibits superior electrochemical performance at high current densities (FIGS. 4B, 4C). The performances of the two catholytes, NYZC-0.625 and NYZC-2.25, show little difference at lower C-rates (0.1 and 0.2 C). It should be noted that although the normalized capacities are similar, the cathode utilization is lower in the case of the stoichiometric phase, as previously indicated. At higher current rates (0.5 and 1 C), the difference in the performance of Na-deficient and stoichiometric compositions become apparent. Na-deficient composition enables the cathode to deliver nearly 80% (˜97 mAh g⁻¹) and 60% (˜70 mAh g⁻¹) of its initial discharge capacity at 0.5 C and 1 C, respectively, while the values are only 70% (71 mAh g⁻¹) and 40% (43 mAh g⁻¹) when using stoichiometric NYZC-2.25 system. The low ionic conductivity of the stoichiometric composition manifests as greater overpotential, especially at high current rates, indicating a higher overall resistivity of the cathode composite and a lower utilization of its capacity.

Beyond the rate study, long-term cycling at 0.33 C also shows that the Na-deficient NYZC-0.625 composition leads to a better performance with an average CE of 99.8% and a capacity retention of 83.3% is achieved after 200 cycles (FIG. 4D). Conversely, an average CE of 99.6% and a capacity retention of 58.2% are observed after 200 cycles for the stoichiometric NYZC-2.25. Previously, the oxidative stability window for NYZC-2.25 was reported to be upwards of 3.8 V vs. Na/Na⁺.⁴ The electrochemical stability window for the Na-deficient NYZC-0.625 composition was measured (FIG. 4F) and found to be similar to that of the stoichiometric phase. Moreover, there is a four order of magnitude difference between the ionic and electronic conductivities of the Na-deficient phase, indicating the Na-deficient composition remains a good solid electrolyte.

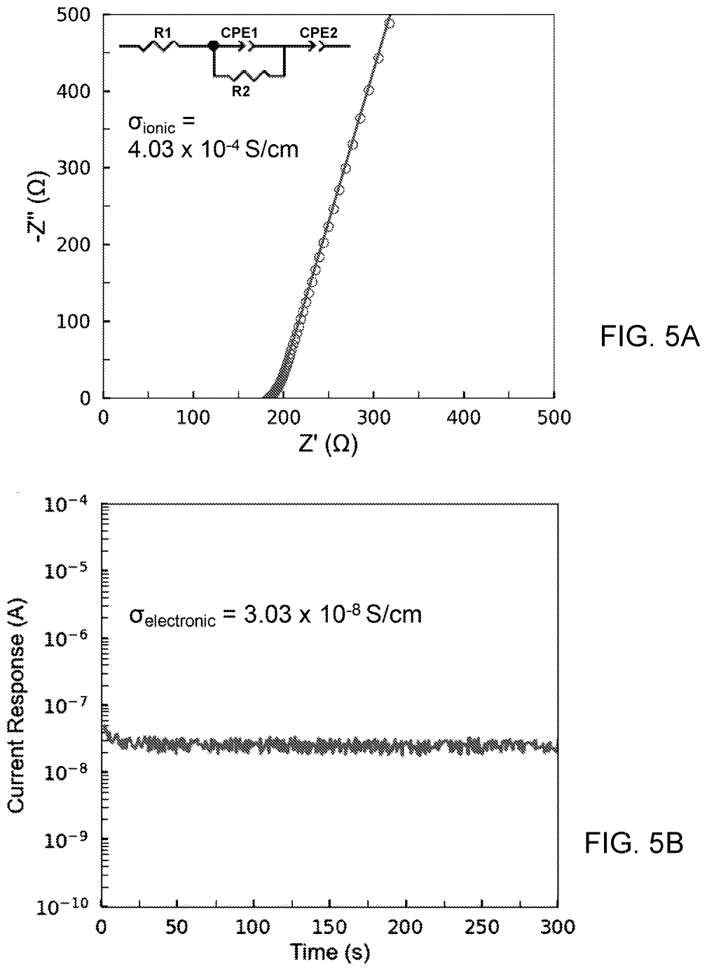

FIG. 5A provides the EIS measurement and the fitted result for the highest conducting sample Na_{0.625}Y_{0.25}Zr_{0.75}C_{14.375} (x=0.625). The equivalent circuit for the EIS measurement is shown in the inset. FIG. 5B plots the direct current polarization measurement using a 50-mV applied potential. While both materials are expected to be both chemically and electrochemically stable under these cycling conditions, the Na-deficient phase possessed a higher ionic conductivity, helping to improve the performance of Na-ASSBs at room temperature.

### Example 2: SE Group #2

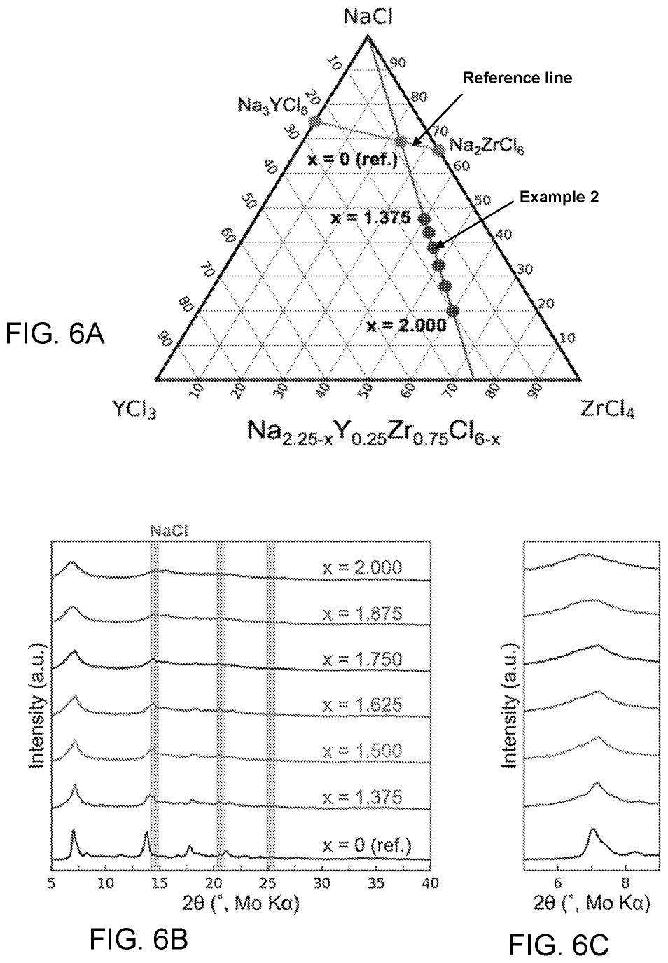

FIG. 6A provides the NaCl—YCl₃—ZrCl₄ ternary composition diagram for samples evaluated in conjunction with Example 2. Here, the points along the line labeled “Example 2” correspond to Na_{2.25-x}Y_{0.25}Zr_{0.75}Cl₆₋ₓ (1.325≤x≤2.000). The “Reference Line” includes previously reported ternary phases Na₃YCl₆ and Na₂ZrCl₆, and the aliovalently substituted Na_{2.25}Y_{0.25}Zr_{0.75}Cl₆ (x=0) phase. Except where otherwise indicated, measurements were performed using the same instruments and procedures as described above for Example 1, SE Group #1.

### Preparation of SE Group #2 Samples:

All materials were synthesized under an inert Ar atmosphere. NaCl (Sigma-Aldrich, 99%), YCl₃ (Sigma-Aldrich, 99.9%), and ZrCl₄ (Sigma-Aldrich, 99.9%) anhydrous powders were used as received from the materials vendor. Mechanochemical synthesis was carried out using a high-energy Retsch E_{MAX} ball mill, where a 30:1 mass ratio of 5 mm yttrium-stabilized zirconia grinding media to precursor powder was used. 1 g of stoichiometric amounts of Na_{2.25-x}Y_{0.25}Zr_{0.75}Cl₆₋ₓ (where x=1.375, 1.5, 1.625, 1.75, 1.875, and 2) powders were prepared by hand mixing the precursor powders with a mortar and pestle before loading the powders into the milling jars, which were hermetically sealed in the glovebox. Samples were ball milled at 500 RPM for a total of 5 h.

The Na_{0.625}Y_{0.25}Zr_{0.75}C_{14.375} (x=1.625) and Na_{0.25}Y_{0.25}Zr_{0.75}Cl₄ (x=2.000) compositions were subjected to heat treatments to induce crystallization. The powders were cold pressed into pellets, loaded into quartz ampoules, and then flame sealed under a vacuum. The pelletized samples were heated at 100° C. for a duration of 2 h. Na₂(B₁₂H₁₂)_{0.5}(B₁₀H₁₀)_{0.5} powders were prepared by ball milling a stoichiometric ratio Na₂B₁₀H₁₀ (Boron Specialties) and Na₂B₁₂H₁₂ (Boron Specialties) precursor powders together for a total of 2 h at 500 rpm. The SE powder was collected and subsequently dried under vacuum at 175° C. for 48 h.

X-ray diffraction (XRD) patterns obtained on the Na_{2.25-x}Y_{0.25}Zr_{0.75}Cl₆₋ₓ samples after ball milling exhibit only several low intensity diffraction peaks (FIG. 6B). Notably, no significant diffraction peaks from the NaCl, YCl₃, or ZrCl₄ precursors are observed after ball milling, except from a small amount of NaCl impurity in the high sodium-containing samples (when x≤1.875). The observable diffraction peaks for the Na_{2.25}Y_{0.25}Zr_{0.75}Cl₆ compositional series are remarkably broad, indicating the formation of low crystallinity products. This is likely due to small crystallite sizes and strain broadening effects arising from particle fracturing and the introduction of defects during the harsh mechanochemical synthesis step. Interestingly, as the NaCl molar content is reduced, or the x value in Na_{2.25-x}Y_{0.25}Zr_{0.75}Cl₆₋ₓ is increased from x=1.375 to x=2.000, a general broadening of the main diffraction peaks at low 20 angles is observed, as shown in FIG. 6C, suggesting that NaCl-poor compositions tend to form smaller domain sizes. Interestingly, at the composition where the NaCl molar content is lowest (x=2.000), the diffraction pattern is nearly featureless and the main reflection is noticeably broad, which indicates that the obtained phase lacks any significant long-range ordering.

To analyze the sample's microstructure, transmission electron microscopy (TEM) and selected area electron diffraction (SAED) experiments were conducted on the end-member and intermediate compositions (i.e., x=1.375, 1.625, and 2.000). TEM characterization was carried out on a Talos F200X Scanning/Transmission Electron Microscope with an accelerating voltage of 200 kV. The microscope is equipped with a CETA camera and a low-dose system. The SAED images were acquired with an electron dose rate of ˜0.05 e Å-2 s-1 for ˜8 s.

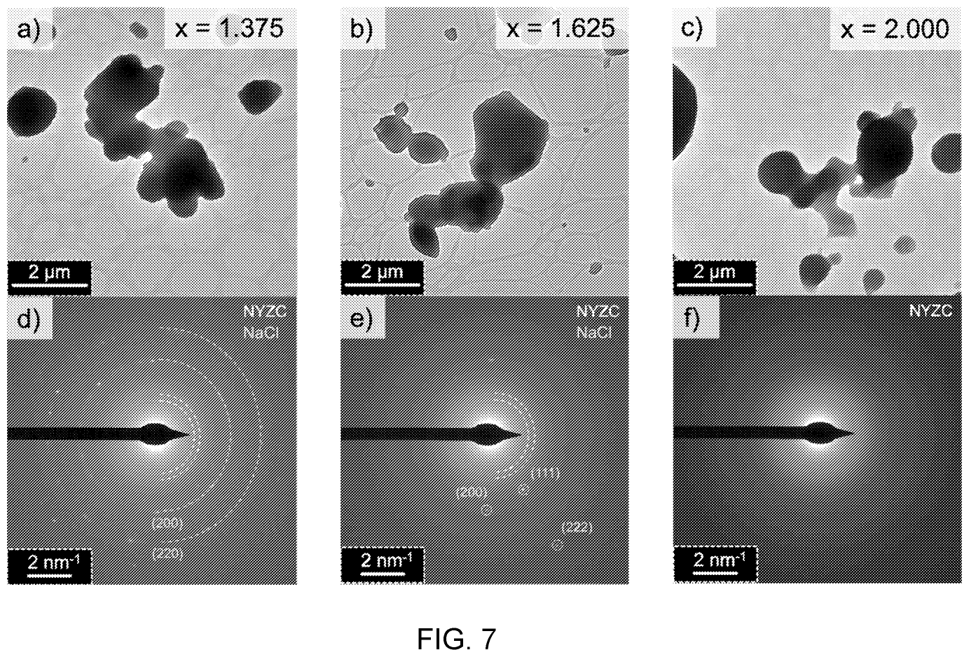

TEM images in panels a-c of FIG. 7 show SE particles ranging from ˜1-2 μm in size. SAED images for the x=1.375 and x=1.625 compositions (FIG. 7, panels d-e) reveal signatures of an NaCl impurity, as indicated by the diffraction rings in FIG. 7, panel d and diffraction spots in FIG. 7, panel e, which correspond to the d-spacing of the marked lattice planes. The remaining powder rings with larger d-spacing can be attributed to the main XRD peaks at lower 2θ (FIG. 7, panel b) and correspond to the Na_{2.25}Y_{0.25}Zr_{0.75}Cl₆ phase (marked in white as NYZC). Furthermore, the smoothness and absence of individual reflections in the NYZC diffraction rings for the x=1.375 and x=1.625 compositions indicates that these samples are not only polycrystalline but possess very fine or even nanocrystalline grains. Conversely, the diffraction rings of the x=2.000 sample merge and a halo pattern (FIG. 7, panel f) is observed, suggesting that samples at higher x values only exhibit short-range order. However, the presence of an amorphous phase for compositions of x<2.000 cannot be entirely ruled out as some fractions of amorphous products are normally expected to be present in the sample when mechanochemical synthesis approaches are used. Although it can be difficult to discern between nanocrystalline and fully amorphous states when analyzing bulk XRD patterns, the complementary TEM and SAED analyses indicate that the samples transition from a nanocrystalline state to a fully amorphous state as x increases from 1.375 to 2.000 in Na_{2.25-x}Y_{0.25}Zr_{0.75}Cl₆₋ₓ.

### Local Na Environment and Ionic Conductivity

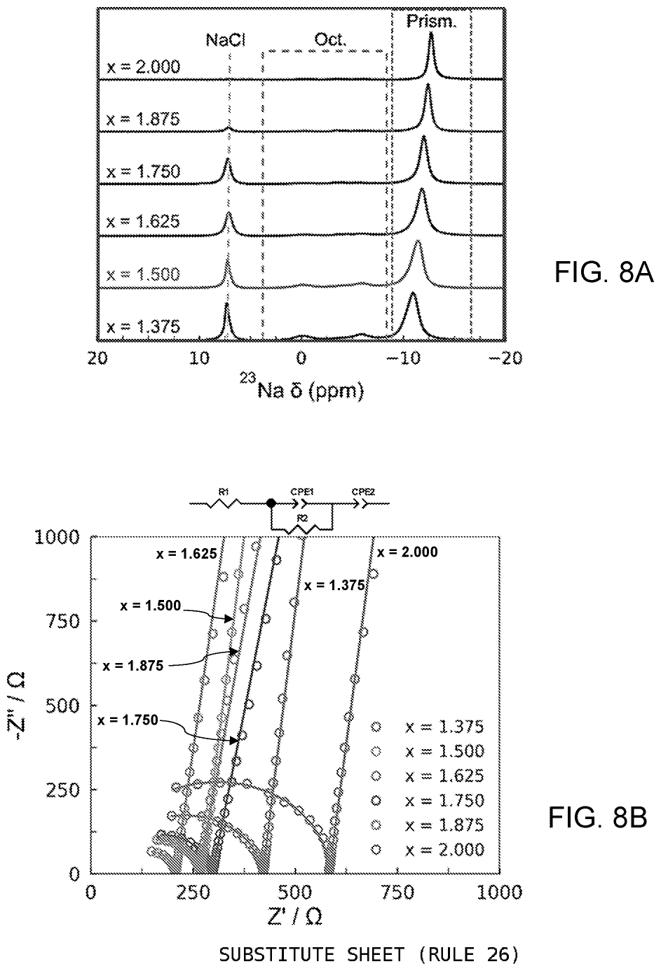

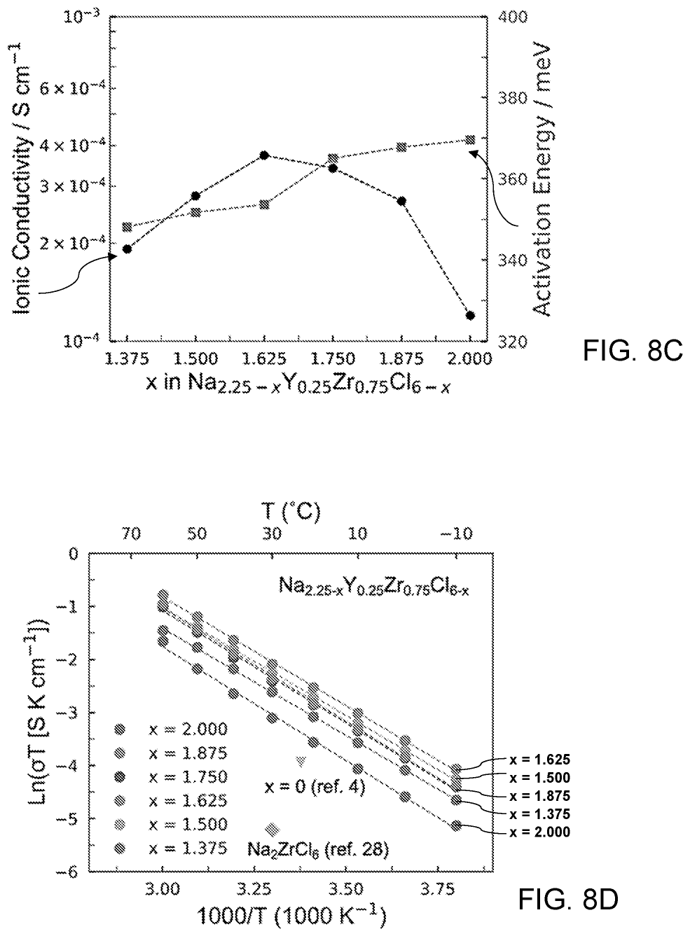

Due to the nanocrystalline and amorphous nature of the Na_{2.25-x}Y_{0.25}Zr_{0.75}Cl₆₋ₓ (1.325≤x≤2.000) compositional series, local Na environments in these different samples were studied using ²³Na solid-state nuclear magnetic resonance (ss-NMR) spectroscopy. The resulting room temperature ²³Na ss-NMR spectra are presented in FIG. 8A. The peak located around 7.2 ppm, observed in almost all of the samples, is attributed to unreacted NaCl precursor, which agrees well with the XRD and SAED results. The NaCl impurity was quantified and determined to be ˜4 wt. % on average (see Table 3).

TABLE 3

| x value | Nominal composition | Wt. % NaCl |
|---|---|---|
| 1.375 | Na_{0.875}Y_{0.25}Zr_{0.75}Cl_{4.625} | 4.8 |
| 1.500 | Na_{0.750}Y_{0.25}Zr_{0.75}Cl_{4.500} | 3.8 |
| 1.625 | Na_{0.625}Y_{0.25}Zr_{0.75}Cl_{4.375} | 5.6 |
| 1.750 | Na_{0.500}Y_{0.25}Zr_{0.75}Cl_{4.250} | 7.3 |
| 1.875 | Na_{0.375}Y_{0.25}Zr_{0.75}Cl_{4.125} | 1.7 |
| 2.000 | Na_{0.250}Y_{0.25}Zr_{0.75}Cl_{4.000} | 0.1 |

As the molar content of NaCl decreases (x increases) in the sample, a corresponding reduction in NaCl signal intensity is observed. To obtain the specific composition of the Na_{2.25-x}Y_{0.25}Zr_{0.75}Cl₆₋ₓ (1.325≤x≤2.000) samples, adjusted x values were calculated by comparing ss-NMR signal areas from the resonances attributed to NaCl and Na_{2.25-x}Y_{0.25}Zr_{0.75}Cl₆₋ₓ phases. Our analysis shows that these adjusted x values are slightly higher but generally vary linearly with the stoichiometric x value, showing that higher x values clearly result in decreasing NaCl contents. Furthermore, the two weak and broad signals detected in the range of ˜−2.5 to 8 ppm are attributed to octahedral Na environments, while the intense resonance between ˜−10 and −13 ppm are assigned the Na in (a) prismatic environment(s) on the basis of the ²³Na ss-NMR data and first principles calculations of NMR shifts previously reported for the related, crystalline Na_{2.25}Y_{0.25}Zr_{0.75}Cl₆ compound.³⁰ Interestingly, the prismatic Na resonance can clearly be observed at all values of x, while signals corresponding to octahedral Na environments can only be detected when x≤1.750. Hence, Na⁺ ions tend to first occupy prismatic environments, which is similar to what has been reported in some chloride SEs. With more Na in octahedral sites in the samples at higher NaCl contents, the prismatic resonance shifts towards more positive ppm frequencies (towards the octahedral Na resonances) and broadens. This evolution could be attributed to changes in Na mobility and increased chemical exchange between prismatic and octahedral sites, resulting in a broadening of the corresponding ²³Na NMR resonances that draw closer to one another in the intermediate exchange regime, i.e., when the exchange constant (kₑₓ) is on par with the frequency separation of the resonances corresponding to the exchanging sites (Δv, in Hz). 2D ²³Na exchange spectroscopy (EXSY) experiments, carried out on the x=1.625 composition, show that Na in octahedral and prismatic sites have the possibility to be in exchange. Nevertheless, a structural explanation cannot be ruled out as the impact on ²³Na chemical shift from possible structural differences such as lattice constant variation and increased Na site disorder is unknown.

The SEs' ionic conductivities were extracted from EIS measurements. C|SE|C cells were assembled using a 10 mm diameter polyether ether ketone (PEEK) die, where SE pellets were formed by cold pressing 100 mg of SE powder at a pressure of ˜300 MPa. The EIS data was acquired using a Biologic SP-200 impedance analyzer with a sinusoidal amplitude of 10 mV within a frequency range of 7 MHz to 1 Hz.

FIG. 8B shows the room temperature Nyquist plots obtained from electrochemical impedance spectroscopic measurements on all of the Na_{2.25-x}Y_{0.25}Zr_{0.75}Cl₆₋ₓ compositions, while the evolution of the ionic conductivity with x is presented in FIG. 8C. All SE samples exhibit high Na⁺ conductivities (>1.0×10⁻⁴ S cm⁻¹), with a maximum value of 4.0×10⁻⁴ S cm⁻¹ for the x=1.625 composition. Notably, these conductivity values are all significantly higher than what has previously been reported for Na—Y—Zr—Cl phases. Moreover, DC polarization measurements confirm that electronic conduction is negligible, with all compositions exhibiting electronic conductivities on the order of 10⁻⁹ S cm⁻¹, as summarized in Table 4.

TABLE 4

| | | | | | Activation |
|---|---|---|---|---|---|
| | | | σ_{Na} | σ_{electronic} | Energy |
| Composition | x value | Nominal composition | (S cm⁻¹) | (S cm⁻¹) | (meV) |
| 7NaCl•2YCl₃•6ZrCl₄ | 1.375 | Na_{0.875}Y_{0.25}Zr_{0.75}Cl_{4.625} | 2.3 × 10⁻⁴ | 3.3 × 10⁻⁹ | 348 |
| 6NaCl•2YCl₃•6ZrCl₄ | 1.500 | Na_{0.750}Y_{0.25}Zr_{0.75}Cl_{4.500} | 3.8 × 10⁻⁴ | 7.9 × 10⁻⁹ | 352 |
| 5NaCl•2YCl₃•6ZrCl₄ | 1.625 | Na_{0.625}Y_{0.25}Zr_{0.75}Cl_{4.375} | 4.0 × 10⁻⁴ | 6.9 × 10⁻⁹ | 354 |
| 4NaCl•2YCl₃•6ZrCl₄ | 1.750 | Na_{0.500}Y_{0.25}Zr_{0.75}Cl_{4.250} | 3.4 × 10⁻⁴ | 2.8 × 10⁻⁹ | 365 |
| 3NaCl•2YCl₃•6ZrCl₄ | 1.875 | Na_{0.375}Y_{0.25}Zr_{0.75}Cl_{4.125} | 2.3 × 10⁻⁴ | 9.9 × 10⁻⁹ | 368 |
| 2NaCl•2YCl₃•6ZrCl₄ | 2.000 | Na_{0.250}Y_{0.25}Zr_{0.75}Cl_{4.000} | 1.2 × 10⁻⁴ | 1.4 × 10⁻⁹ | 370 |

As the NaCl content is decreased below x=1.625, the ionic conductivity begins to drop. Yet the sample with the lowest molar content of NaCl (x=2.000) still exhibits an ionic conductivity of 1.2×10⁻⁴ S cm⁻¹, which is comparable to cubic NPS (1.4×10⁻⁴ S cm⁻¹) and is still higher than all other previously reported chloride-based Na-ion conductors. The high conductivity of Na_{2.25-x}Y_{0.25}Zr_{0.75}Cl₆₋ₓ compounds at high x is likely in part due to a vacancy-mediated Na⁺ transport mechanism and a high Na mobility afforded by the high concentration of Na vacancies per unit volume.

Arrhenius plots obtained for all Na_{2.25-x}Y_{0.25}Zr_{0.75}Cl₆₋ₓ compositions show that ln(σT) vs. f(1/T) evolves linearly within the temperature range probed (FIG. 8D). Thus, the activation energy for Na⁺ diffusion can be extracted by linearizing the Arrhenius equation (Equation (3) above).

All Na_{2.25-x}Y_{0.25}Zr_{0.75}Cl₆₋ₓ compositions possess activation energies in the range of 348-370 meV (Table 4), which are all appreciably lower than that of the reference Na_{2.25}Y_{0.25}Zr_{0.75}Cl₆ phase (664 meV) and again fairly similar to cubic NPS (364 meV). The evolution of the activation energy and ionic conductivity with NaCl content x is shown in FIG. 8D, and demonstrates that there is little to no correlation between the measured ionic conductivity and the activation energy, as has been reported for other amorphous ionic conductors.

Because amorphous materials possess lower densities than their crystalline counterparts, free volume—a consequence of their non-periodicity and lower packing densities—is allowed. Free volume has been previously shown to facilitate ion mobility and thus enhance ionic conductivity. Here, it is speculated that the nanocrystalline and amorphous nature of the Na_{2.25-x}Y_{0.25}Zr_{0.75}Cl₆₋ₓ compounds leads to more free volume as compared to the more crystalline reference Na_{2.25}Y_{0.25}Zr_{0.75}Cl₆ SE, which may be one contributing factor to the improved Na⁺ mobility and lower migration energy barriers. Additionally, as the ratio of Y/Zr is fixed, a reduction in NaCl content will also reduce the population of Na⁺ sites, leading to an increased concentration of Na vacancies that could further aid Na⁺ transport. However, since the total conductivity is a product of n_{Na} and μ_{Na}, a balance must be struck between the two to achieve the highest conductivity, as the ionic conductivity of a single ion conductor is determined by Equation (2) above.

Although ²³Na ss-NMR suggests that Na⁺ mobility increases at higher x values, there will be an insufficient number of charge carriers when the concentration of Na⁺ per unit volume is too low. As such, the Na_{0.625}Y_{0.25}Zr_{0.75}C_{14.375} (x=1.625) composition appears to be the preferred composition, balancing the concentration of mobile Na⁺ charge carriers and their mobility.

Crystallization Behavior of Na_{2.25-x}Y_{0.25}Zr_{0.75}Cl₆₋ₓ Solid Electrolytes

To better understand the impact of sample crystallinity and local structure on Na⁺ mobility, the composition with the highest ionic conductivity (x=1.625) and the fully amorphous (x=2.000) sample were selected for further study. These two samples were heat-treated at 100° C. for 2 h to induce crystallization. This temperature was selected based on differential scanning calorimetry measurements, where an exothermic phase transition (i.e., crystallization) was observed to have an onset temperature below 100° C.

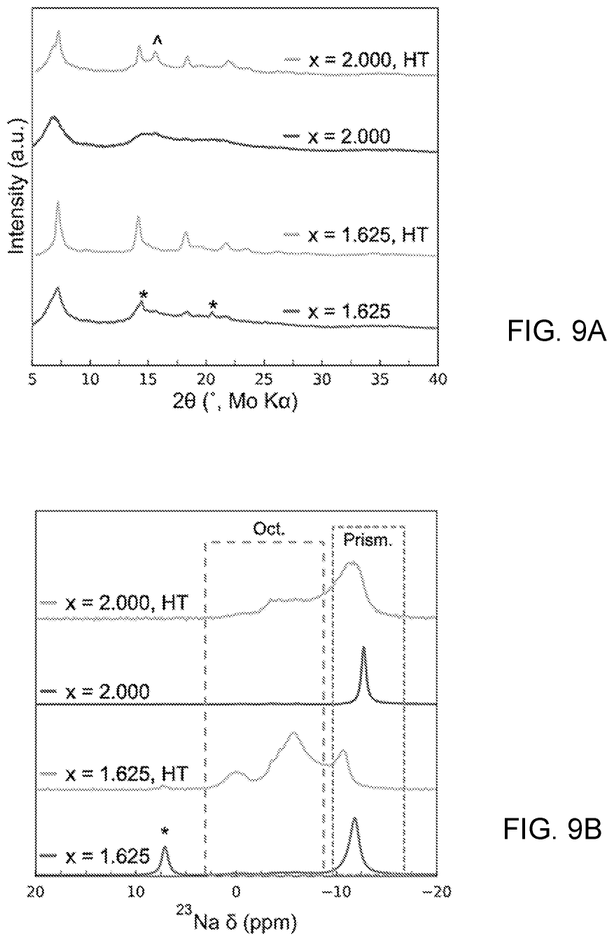

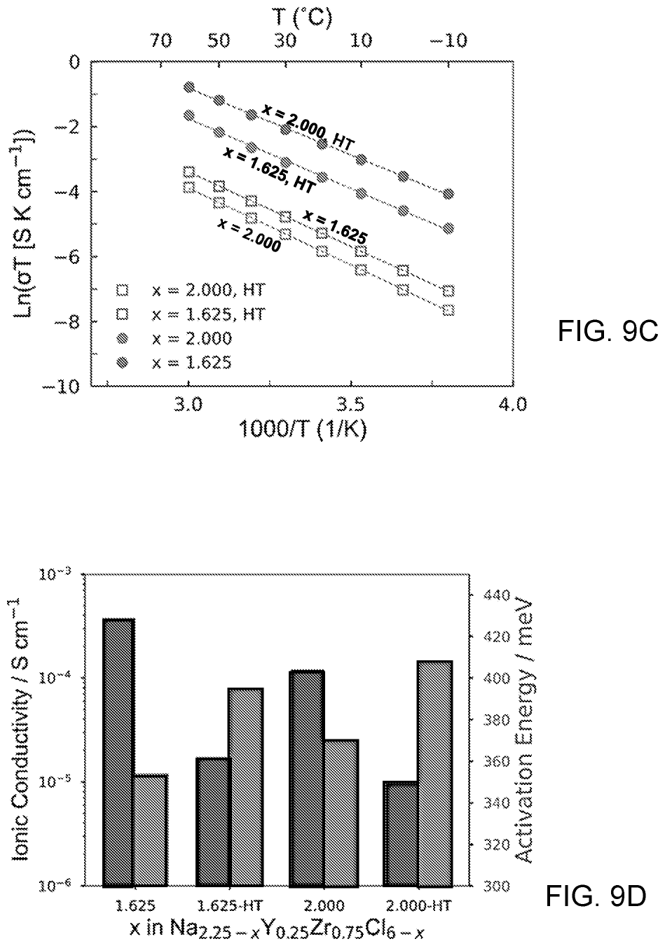

XRD patterns of the two compositions (x=1.625 and x=2.000) were collected after the thermal treatment step and are shown in FIG. 9A. In the case of the x=1.625 composition, upon heating, all linewidths of the diffraction peaks associated with the Na_{2.25-x}Y_{0.25}Zr_{0.75}Cl₆₋ₓ phase become significantly narrower, which is attributed to crystallization. For the x=2.000 composition, new diffraction peaks corresponding to the Na_{2.25-x}Y_{0.25}Zr_{0.75}Cl₆₋ₓ phase appear along with the highest intensity diffraction peak for crystalline ZrCl₄ corresponding to the (121) plane. However, the broad diffraction peak at low 2θ angles, corresponding to the amorphous constituent, is still apparent after heat-treatment, suggesting incomplete crystallization.

A comparison of the ²³Na ss-NMR spectra obtained on the x=1.625 sample before and after the heat treatment show that the excess NaCl in the pristine (untreated) sample is consumed and incorporated into the Na_{2.25-x}Y_{0.25}Zr_{0.75}Cl₆₋ₓ phase when the sample is subjected to heating at 100° C. (FIG. 9B). Furthermore, the signal corresponding to prismatic Na broadens and decreases in intensity, while the signals attributed to octahedral Na environments grow significantly. A similar evolution of the ²³Na NMR spectrum is observed for the x=2.000 sample. Thus, the 100° C. heat treatment promotes crystallization of these two Na_{2.25-x}Y_{0.25}Zr_{0.75}Cl₆₋ₓ phases, which is accompanied by a redistribution of Na from prismatic environments to octahedral sites in the structure and increased exchange between the environments. Consequently, the two crystallized samples exhibit roughly one order of magnitude lower ionic conductivities and increased activation energies as compared to their nanocrystalline/amorphous analogues (FIGS. 9C, 9D). This finding agrees well with the decrease in conductivity observed for some disordered chloride SEs subjected to a heat treatment or annealing step. Clearly, for the Na_{2.25-x}Y_{0.25}Zr_{0.75}Cl₆₋ₓ compounds of interest to the present work, smaller grain sizes and amorphization lead to rapid Na⁺ exchange between prismatic sites, which are key for achieving high Na⁺ conductivity.

### Electrochemical Testing

The room temperature performance of two solid-state batteries comprising either the most conductive Na_{2.25-x}Y_{0.25}Zr_{0.75}Cl₆₋ₓ compound (x=1.625), or the fully amorphous compound (x=2.000) were evaluated. Before assembling the solid-state batteries, the electrochemical stability window of the two materials was examined using linear sweep voltammetry, which was conducted using the following cell configuration: Na₉Sn₄|NBH|Chloride SE|Chloride SE/AB composite. The positive electrode composite consisted of 80 wt. % chloride SE and 20 wt. % acetylene black (AB) conductive additive, which was added to ensure electronic percolation within the composite to accurately assess its redox processes.

Electrochemical performance was tested with the cell configuration Na₉Sn₄|NBH|Cathode composite with the respective amounts of 35, 50, and 16.54 mg of each material. The cathode composites were NaCrO₂, Na_{2.25-x}Y_{0.25}Zr_{0.75}Cl₆₋ₓ (where x=1.625 or 2), and vapor grown carbon fiber (VGCF) conductive additive in a weight ratio of 11:16:0.5. Constant current cycling of the fabricated cells was carried out at an ambient temperature of approximately 23° C., within the voltage range of 1.7-3.4 V versus Na₉Sn₄, and under an applied stack pressure of ˜50-70 MPa.

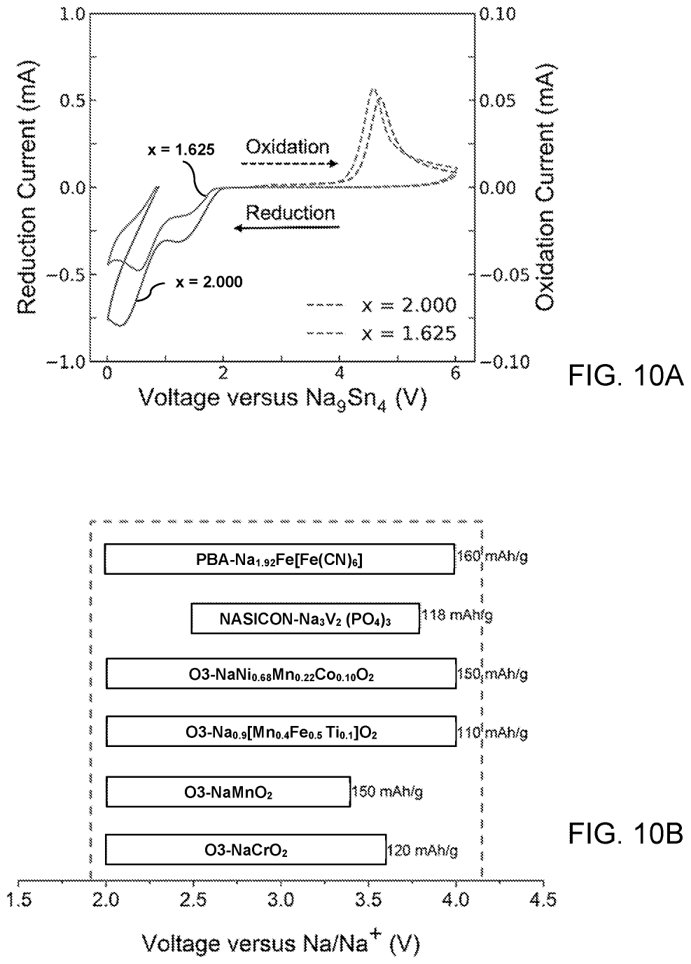

FIG. 10A provides the results of this testing. The x=1.625 and x=2.000 samples exhibit a peak oxidation current at ˜4.6 and 4.7 V vs. the reference electrode (Na₉Sn₄), with the onset of this peak taking place near 4.0 and 4.1 V, respectively. During the reduction sweep, both samples show two reduction peaks at ˜1.4 and 0.55 V vs. the reference, which can be attributed to Zr⁴⁺ and Y³⁺ reduction, respectively,^{4.42} with the onset of the first reduction peak occurring around 1.8 to 2.0 V vs. the reference electrode. Consequently, both samples exhibit a wide electrochemical window and are thus compatible with various sodium-based cathode materials shown in FIG. 10B, making them ideal catholyte materials. NaCrO₂ was selected to be paired with both Na_{2.25-x}Y_{0.25}Zr_{0.75}Cl₆₋ₓ compositions due to its suitable voltage window (1.7-3.4 V), relatively high specific capacity (120 mAh g⁻¹), and excellent reversibility.

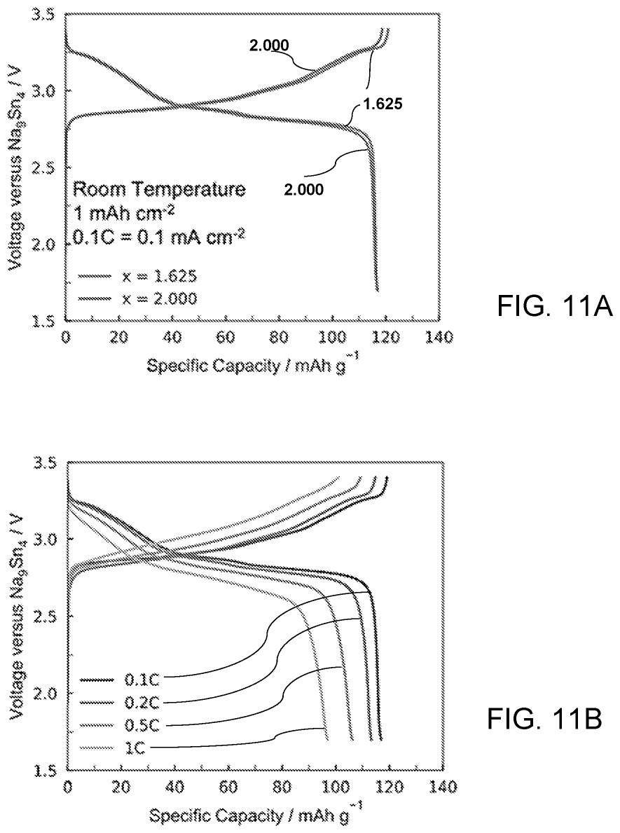

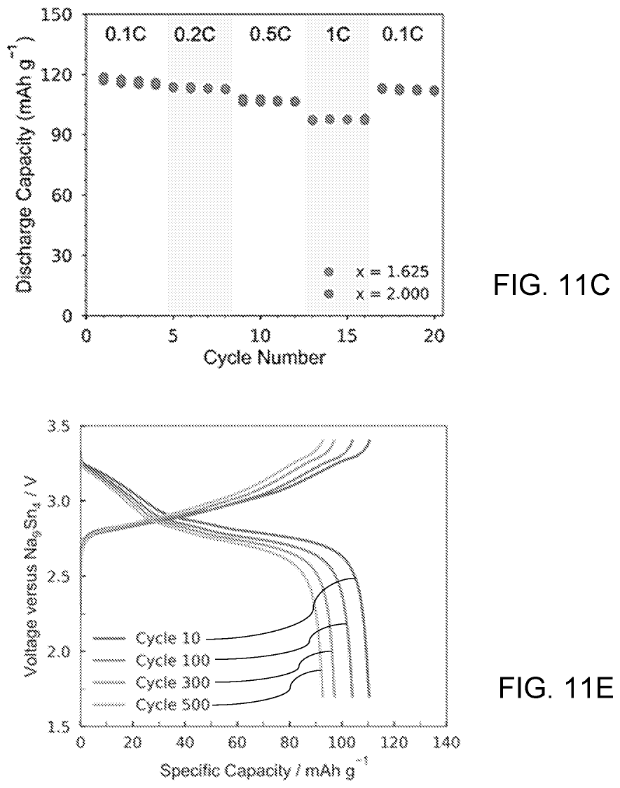

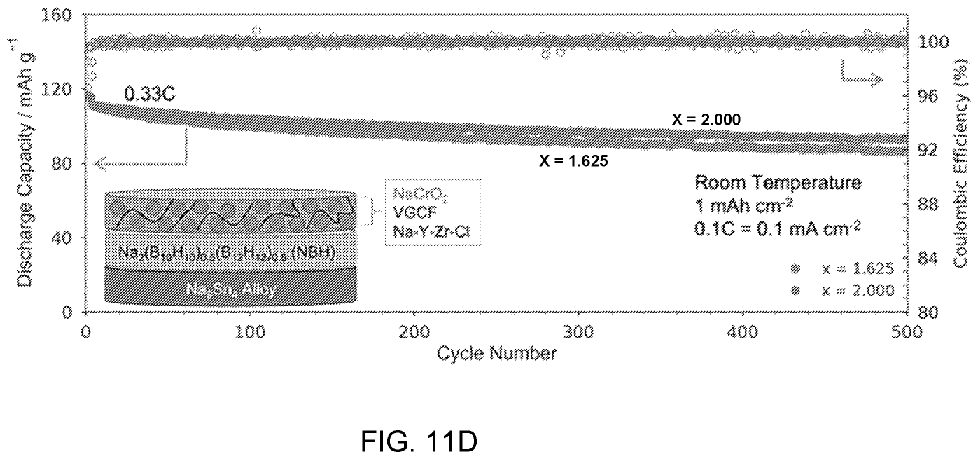

All-solid-state cells using the x=1.625 and x=2.000 catholytes were assembled and cycled at room temperature using an areal loading of 1 mAh cm⁻² (FIG. 9A). AS shown in FIG. 11A, at a 0.1 C current rate (where 1 C=120 mA g⁻¹ or 100 μA cm⁻²), both compositions deliver high initial charge and discharge capacities, with initial Coulombic efficiencies (ICE) values of >96%. These high ICE values can be attributed to the good electrochemical compatibility between the catholyte and the NaCrO₂ cathode. Both compounds are able to deliver near theoretical capacity for NaCrO₂ (˜126 mAh g⁻¹), presumably due to their high ionic conductivities. Moreover, the deformability of these Na_{2.25-x}Y_{0.25}Zr_{0.75}Cl₆₋ₓ catholytes is advantageous as it leads to good contact between cathode and SE particles under cold-pressing conditions, a more uniform current density distribution, and better utilization of the cathode active material in the composite. This can be evidenced by two-dimensional porosity values, which were calculated for a heat-treated x=0 (4.9%) and an as-milled x=1.625 (0.2%) phase, whereby cross-sectional FIB-SEM images were binarized and black pixels were assigned to void space. Besides the softer nature of the chloride anion framework as compared to oxide SEs, we hypothesize that the nanocrystalline and amorphous nature of the present samples could further contribute to their good experimentally observed deformability.

Rate capability tests using a sequence of 0.1, 0.2, 0.5, 1.0, and 0.1 C current rates also revealed that both solid-state cells exhibit excellent performance at higher current densities (FIGS. 11B-11C). The performance of the two cells shows little difference at lower C-rates (0.1 and 0.2 C), or even at higher C-rates (0.5 and 1 C), which is likely due to the similar ionic conductivity values of the x=1.625 and x=2.000 catholytes. (Note that in FIG. 11C, the points for x=1.625 and x=2.000 are essentially overlapping.) Interestingly, at higher current rates, both compositions show good utilization of the cathode active material, reversibly delivering ˜105 mAh g⁻¹ and ˜97 mAh g⁻¹ of capacity at 0.5 and 1 C, respectively.

Beyond the rate study, extended cycling at 0.33 C shows that the two cells containing the x=1.625 and x=2.000 catholytes demonstrate reversible and stable cycling (FIGS. 11D-11E). Average CEs of 99.95% and 99.96%, and capacity retentions of 78% and 83%, are obtained after 500 cycles for the x=1.625 and x=2.000 cells, respectively. The high CEs and low capacity fading at room temperature can be credited to the catholyte being electrochemically stable within the cycling conditions. Previously, the oxidative stability window for the stoichiometric Na_{2.25}Y_{0.25}Zr_{0.75}Cl₆ (x=0) catholyte was reported to be upwards of 3.8 V vs. Na/Na⁺.⁴ Here, a similar electrochemical stability window is observed for both the x=1.625 and x=2.000 compositions. The electrochemical tests conducted here highlight the benefits of utilizing a chloride-based catholyte with a high ionic conductivity and oxidative stability, resulting in good room temperature cell performance.

The approaches disclosed herein provide for the creation of highly conductive chloride-based Na⁺ ion conductors with low crystallinity, i.e., nanocrystalline and/or amorphous characteristics. The use of ball-milling synthesis and Na-deficiency produces synergistic effects on the Na local structure, crystallinity (or lack thereof), and enhances the ionic conductivity of the sample. The as-milled samples obtained from this synthesis approach had their Na⁺ ions residing preferentially in prismatic environments, which possesses a lower activation energy for Na⁺ hopping, leading to fast Na chemical exchange between the sites. Furthermore, the low NaCl molar percentage, combined with ball-milling synthesis, resulted in the formation of samples with low or no crystallinity, i.e., amorphous, which likely exhibit more free volume and higher numbers of Na vacancies as compared to the stoichiometric NYZC-2.25 system, both of which are necessary for achieving high ionic conductivity. Such factors were evidenced using a wide range of bulk and localized characterization techniques like XRD, TEM, SAED, ss-NMR, and EIS measurements. The increased ionic conductivity of compositions with a low NaCl content leads to excellent performance of Na-ASSBs, especially at high current rates and during long-term cycling tests at room temperature. Interestingly, heating the compositions induces crystallization and a corresponding redistribution of Na among prismatic and octahedral sites in the structure, resulting in decreased Na⁺ mobility. This finding further highlights the importance of controlling sample crystallinity and the distribution of Na local environments, suggesting that small grain sizes and fast Na⁺ hopping between prismatic environments is key for achieving high conductivity in this class of materials. This work provides insights into the composition, structure, and conductivity relationships of nanocrystalline and amorphous chlorides, which may be used as design principles and that could lead to a paradigm shift in the development of future Li⁺ and Na⁺ conductors for high-performance room temperature ASSBs.

### REFERENCES (INCORPORATED HEREIN BY REFERENCE)

1. Yang, H.-L. et al. Progress and Challenges for All-Solid-State Sodium Batteries. Advanced Energy and Sustainability Research 2, 2000057 (2021).
2. Hirsh, H. S. et al. Sodium-Ion Batteries Paving the Way for Grid Energy Storage. Advanced Energy Materials 10, 2001274 (2020).
3. Sayahpour, B. et al. Perspective: Design of cathode materials for sustainable sodium-ion batteries. MRS Energy & Sustainability (2022) doi:10.1557/s43581-022-00029-9.
4. Wu, E. A. et al. A stable cathode-solid electrolyte composite for high-voltage, long-cycle-life solid-state sodium-ion batteries. Nat Commun 12, 1256 (2021).
5. Kato, Y. et al. High-power all-solid-state batteries using sulfide superionic conductors. Nat Energy 1, 1-7 (2016).
6. Yamane, H. et al. Crystal structure of a superionic conductor, Li7P3S11. Solid State Ionics 178, 1163-1167 (2007).
7. Kamaya, N. et al. A lithium superionic conductor. Nature Materials 10, 682-686 (2011).
8. Hayashi, A., Noi, K., Sakuda, A. & Tatsumisago, M. Superionic glass-ceramic electrolytes for room-temperature rechargeable sodium batteries. Nature Communications 3, 856 (2012).
9. Song, S., Duong, H. M., Korsunsky, A. M., Hu, N. & Lu, L. A Na+ Superionic Conductor for Room-Temperature Sodium Batteries. Scientific Reports 6, 32330 (2016).
10. Hayashi, A. et al. A sodium-ion sulfide solid electrolyte with unprecedented conductivity at room temperature. Nat Commun 10, 5266 (2019).
11. Liu, Y. et al. Development of the cold sintering process and its application in solid-state lithium batteries. Journal of Power Sources 393, 193-203 (2018).
12. Ke, X., Wang, Y., Ren, G. & Yuan, C. Towards rational mechanical design of inorganic solid electrolytes for all-solid-state lithium ion batteries. Energy Storage Materials 26, 313-324 (2020).
13. Wenzel, S. et al. Interfacial Reactivity Benchmarking of the Sodium Ion Conductors Na3PS4 and Sodium β-Alumina for Protected Sodium Metal Anodes and Sodium All-Solid-State Batteries. ACS Appl. Mater. Interfaces 8, 28216-28224 (2016).
14. Culver, S. P., Koerver, R., Zeier, W. G. & Janek, J. On the Functionality of Coatings for Cathode Active Materials in Thiophosphate-Based All-Solid-State Batteries. Advanced Energy Materials 9, 1900626 (2019).
15. Han, Y. et al. Single- or Poly-Crystalline Ni-Rich Layered Cathode, Sulfide or Halide Solid Electrolyte: Which Will be the Winners for All-Solid-State Batteries? Advanced Energy Materials 11, 2100126 (2021).
16. Asano, T. et al. Solid Halide Electrolytes with High Lithium-Ion Conductivity for Application in 4 V Class Bulk-Type All-Solid-State Batteries. Advanced Materials 30, 1803075 (2018).
17. Li, X. et al. Air-stable Li3InCl6 electrolyte with high voltage compatibility for all-solid-state batteries. Energy Environ. Sci. 12, 2665-2671 (2019).
18. Park, K.-H. et al. High-Voltage Superionic Halide Solid Electrolytes for All-Solid-State Li-Ion Batteries. ACS Energy Lett. 5, 533-539 (2020).
19. Kwak, H. et al. New Cost-Effective Halide Solid Electrolytes for All-Solid-State Batteries: Mechanochemically Prepared Fe3+-Substituted Li2ZrCl6. Advanced Energy Materials 11, 2003190 (2021).
20. Kim, S. Y. et al. Lithium Ytterbium-Based Halide Solid Electrolytes for High Voltage All-Solid-State Batteries. ACS Materials Lett. 930-938 (2021) doi:10.1021/acsmaterialslett.1c00142.
21. Zhou, L. et al. High areal capacity, long cycle life 4 V ceramic all-solid-state Li-ion batteries enabled by chloride solid electrolytes. Nat Energy 1-11 (2022) doi:10.1038/s41560-021-00952-0.
22. Sebti, E. et al. Stacking Faults Assist Lithium-Ion Conduction in a Halide-Based Superionic Conductor. J. Am. Chem. Soc. (2022) doi:10.1021/jacs.1c11335.
23. Schlem, R., Banik, A., Eckardt, M., Zobel, M. & Zeier, W. G. Na3-xEr1-xZrxCl6-A Halide-Based Fast Sodium-Ion Conductor with Vacancy-Driven Ionic Transport. ACS Appl. Energy Mater. 3, 10164-10173 (2020).
24. Liang, J. et al. Site-Occupation-Tuned Superionic LixScCl3+xHalide Solid Electrolytes for All-Solid-State Batteries. J. Am. Chem. Soc. 142, 7012-7022 (2020).
25. Park, D. et al. Materials design of sodium chloride solid electrolytes Na3MCl6 for all-solid-state sodium-ion batteries. J. Mater. Chem. A 9, 23037-23045 (2021).
26. Qie, Y. et al. Yttrium-Sodium Halides as Promising Solid-State Electrolytes with High Ionic Conductivity and Stability for Na-Ion Batteries. J. Phys. Chem. Lett. 8 (2020).
27. Zhang, K. & Jin, Z. Halogen-enabled rechargeable batteries: Current advances and future perspectives. Energy Storage Materials 45, 332-369 (2022).
28. Kwak, H. et al. Na2ZrCl6 enabling highly stable 3 V all-solid-state Na-ion batteries. Energy Storage Materials 37, 47-54 (2021).
29. Zhang, Z. et al. Targeting Superionic Conductivity by Turning on Anion Rotation at Room Temperature in Fast Ion Conductors. Matter 2, 1667-1684 (2020).
30. Harris, R. K. & Nesbitt, G. J. Cross polarization for quadrupolar nuclei—Proton to sodium-23. Journal of Magnetic Resonance (1969) 78, 245-256 (1988).
31. Sebti, E. et al. Synthetic control of structure and conduction properties in Na—Y—Zr—Cl solid electrolytes. Preprint at https://doi.org/10.48550/arXiv.2208.07823 (2022).
32. Yabuuchi, N. et al. New 02/P2-type Li-Excess Layered Manganese Oxides as Promising Multi-Functional Electrode Materials for Rechargeable Li/Na Batteries. Advanced Energy Materials 4, 1301453 (2014).
33. Nguyen, H. et al. Single-step synthesis of highly conductive Na₃PS₄ solid electrolyte for sodium all solid-state batteries. Journal of Power Sources 435, 126623 (2019).
34. Swenson, J. & Börjesson, L. Correlation between Free Volume and Ionic Conductivity in Fast Ion Conducting Glasses. Phys. Rev. Lett. 77, 3569-3572 (1996).
35. Smith, J. G. & Siegel, D. J. Low-temperature paddlewheel effect in glassy solid electrolytes. Nature Communications 11, 1483 (2020).
36. Sakuda, A., Hayashi, A. & Tatsumisago, M. Sulfide Solid Electrolyte with Favorable Mechanical Property for All-Solid-State Lithium Battery. Sci Rep 3, 2261 (2013).
37. van Meerten, S. G. J., Franssen, W. M. J. & Kentgens, A. P. M. ssNake: A cross-platform open-source NMR data processing and fitting application. Journal of Magnetic Resonance 301, 56-66 (2019).

1. An electrolyte for an all-solid-state battery, the electrolyte comprising a composition comprising Na_{3-y}Y_{1-y}Zr_{y}Cl₆ where y is synthesized by mixing NaCl, YCl₃, and ZrCl₄ powders, wherein ionic conductivity of the composition is increased relative to a non-sodium deficient stoichiometric composition by selecting molar ratios and processing the composition to reduce crystallinity and increase a concentration of Na vacancies.

2. The electrolyte of claim 1, wherein processing comprises:
milling the NaCl, YCl₃, and ZrCl₄ powders with a grinding medium in an inert atmosphere until one or more of particle sizes are 20 μm or less and an average crystallite domain size is 100 nm or less.

3. The electrolyte of claim 2, wherein the milling is ball milling in an inert atmosphere.

4. The electrolyte of claim 2, wherein the NaCl, YCl₃, and ZrCl₄ powders are mixed at molar ratios comprising NaₓY_{0.25}Zr_{0.75}Cl_{3.75+x}, where 0.25≤x≤0.875.

5. The electrolyte of claim 4, wherein 0.5≤x≤0.75.

6. The electrolyte of claim 4, wherein x is approximately 0.625.

7. The electrolyte of claim 4, wherein processing further comprises annealing the composition for a period of from 1 hour to 20 hours at a temperature within a range of 50° C.-70° C.

8. The electrolyte of claim 2, wherein the NaCl, YCl₃, and ZrCl₄ powders are mixed at molar ratios comprising Na_{2.25-x}Y_{0.25}Zr_{0.75}Cl₆₋ₓ (1.325≤x≤2.000).

9. The electrolyte of claim 8, wherein 1.5≤x≤1.75.

10. The electrolyte of claim 8, wherein x is approximately 1.625.

11. The electrolyte of claim 2, wherein the average crystallite domain size is less than 8 nm.

12. The electrolyte of claim 2, wherein the ionic conductivity of the composition is within a range of 1.0×10⁻⁴ S cm⁻¹ to 4.0×10⁻⁴ S cm⁻¹.

13. A solid electrolyte for an all-solid-state battery comprising a composition synthesized by ball milling a mixture of NaCl, YCl₃, and ZrCl₄ at molar ratios comprising NaₓY_{0.25}Zr_{0.75}Cl_{3.75+x}, where 0.25≤x≤0.875, or Na_{2.25-x}Y_{0.25}Zr_{0.75}Cl₆₋ₓ, where 1.325≤x≤2.000, until the composition has an ionic conductivity within a range of 1.0×10⁻⁴ S cm⁻¹ to 4.0×10⁻⁴ S cm⁻¹.

14. The electrolyte of claim 13, wherein the molar ratios comprise NaₓY_{0.25}Zr_{0.75}Cl_{3.75+x} and 0.5 x≤0.75.

15. The electrolyte of claim 14, wherein x is approximately 0.625.

16. The electrolyte of claim 13, where the molar ratios comprise Na_{2.25-x}Y_{0.25}Zr_{0.75}Cl₆₋ₓ and 1.5 x≤1.75.

17. The electrolyte of claim 16, wherein x is approximately 1.625.

18. (canceled)

19. A method for forming a solid electrolyte from a mixture of NaCl, YCl₃, and ZrCl₄ at molar ratios comprising NaₓY_{0.25}Zr_{0.75}Cl_{3.75+x}, where 0.25≤x≤0.875, or Na_{2.25-x}Y_{0.25}Zr_{0.75}Cl₆₋ₓ, where 1.325≤x≤2.000, using ball-milling synthesis in an inert atmosphere until the mixture has one or more of particle sizes of 20 μm or less and an average crystallite domain size of 100 nm or less.
